(19) United States
(12) Patent Application Publication
(10) Pub. No.: US 2016/0043899 A1
(43) Pub. Date: Feb. 11, 2016

(54) MANAGEMENT COMPUTER, MANAGEMENT METHOD, AND NON-TRANSITORY RECORDING MEDIUM

(71) Applicant: Hitachi, Ltd., Tokyo (JP)

(72) Inventors: Yoji OZAWA, Tokyo (JP); Yukio OGAWA, Tokyo (JP); Junji KINOSHITA, Tokyo (JP); Kosuke KANEKO, Tokyo (JP); Osamu TAKADA, Tokyo (JP)

(21) Appl. No.: 14/819,788

(22) Filed: Aug. 6, 2015

(30) Foreign Application Priority Data
Aug. 8, 2014 (JP) 2014-162131

(51) Int. Cl. H04L 12/24

(52) U.S. Cl. CPC H04L 41/0816

(57) ABSTRACT

A management computer coupled to a network device comprises: a processor; and a storage unit that stores effect determination information that defines conditions for determining an effect of an operation by the network device, the conditions being applied to a combination of setting items for the network device, and wherein the processor executes: to select, from among the combination of setting items, a specific combination matching a combination of a first setting item for the network device and a second setting item associated with the first setting item; to determine whether or not the combination of the first setting item and the second setting item satisfies the conditions applied to the specific combination if the specific combination is selected; to identify the presence or absence of an effect resulting from an operation of the network device on the basis of determination results; and to output identification results.

### CLAIM OF PRIORITY

The present application claims priority from Japanese patent application JP 2014-162131 filed on Aug. 8, 2014, the content of which is hereby incorporated by reference into this application.

### BACKGROUND

The disclosed subject matter relates to a management computer that manages a network device, a management method, and a management program.

Networks, which are the foundation of business systems, have various appliances such as firewalls and load balancers, and network settings are frequently modified as a result of updating business systems and the like. If an error occurs when modifying network settings, this affects many business systems. To provide a highly reliable network infrastructure, it is necessary to modify settings without any errors. In particular, it is necessary to confirm whether or not the settings are correct prior to actually applying the settings to the network.

Specifically, it is necessary to confirm that settings to be applied will not affect operations dependent on items already set, and that even if settings to be applied are already set, operations will occur as expected. Conventional techniques for confirming settings prior to applying them include a technique of simulating network operations, and confirming if operations occur as expected (see JP 2011-193327 A, paragraphs [0013]-[0024], and FIGS. 2 and 3). Also, distributed systems include a technique that confirms consistency by defining the consistency between individual parameters as a rule and confirming whether the actual parameters conform to the rule (see JP 2006-318371 A, paragraphs [0036]-[0046], FIGS. 2 and 3).

### SUMMARY

The following are problems present in conventional techniques. The conventional technique disclosed in JP 2011-193327 A simulates mainly for routing settings. However, networks include various network devices such as firewalls (sometimes abbreviated as “FW” below), load balancers (sometimes abbreviated as “LB” below), virtual private network (VPN) devices, intrusion detection systems (IDS), and intrusion prevention systems (IPS), and these include various settings. The conventional technique disclosed in JP 2011-193327 A cannot handle such a variety of settings.

Also, there are various already existing configurations for network settings, and there are vast numbers of possible combinations with setting content that is planned to be applied. Thus, there would be a vast number of rules checking for consistency among the individual parameters, and it would be necessary to select the rule to apply depending on the combination between already existing configurations and setting content. Thus, the conventional technique disclosed in JP 2006-318371 A has the problem that it is difficult to confirm the effect with already existing settings, and to verify whether or not the setting content is correct.

The disclosure provides for a method for reducing omissions of verification in a network configuration.

An aspect of the disclosure in this application is a management computer coupled to a network device, comprising: a processor that executes a program; a storage unit that stores the program to be executed by the processor; and an interface that controls communication with the network device, wherein the storage unit stores effect determination information that defines conditions for determining an effect of an operation by the network device, the conditions being applied to a combination of setting items for the network device, and wherein the processor executes: a selection process of selecting, from among the combination of setting items for the network device in the effect determination information, a specific combination matching a combination of a first setting item for the network device and a second setting item associated with the first setting item for the network device; a determination process of determining whether or not the combination of the first setting item and the second setting item satisfies the conditions applied to the specific combination if the specific combination is selected in the selection process; an identification process of identifying the presence or absence of an effect resulting from an operation of the network device on the basis of determination results obtained by the determination process; and an output process of outputting identification results obtained by the identification process.

According to the teaching herein, it is possible to reduce omissions of verification in the network configuration.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a descriptive drawing showing an overlap determination example 1 using a flow space in a case in which settings of a network device are selected.

FIG. 2 is a descriptive drawing showing an overlap determination example 2 using a flow space in a case in which settings of a network device are selected.

FIG. 3 is a descriptive drawing showing an overlap determination example 3 using a flow space having end to end conditions.

FIG. 4 is a block diagram showing a system configuration example for a network system of Embodiment 1.

FIG. 5 is a block diagram showing a hardware configuration example of the management computer.

FIG. 6 is a descriptive drawing showing one example of the setting modification request information shown in FIG. 5.

FIG. 7 is a descriptive drawing showing one example of the existing setting instance list information shown in FIG. 5.

FIG. 8 is a descriptive drawing showing one example of the first correspondence information shown in FIG. 5.

FIG. 9 is a descriptive drawing showing one example of the second correspondence information shown in FIG. 5.

FIG. 10 is a descriptive drawing showing one example of the effect determination information shown in FIG. 5.

FIG. 11 is a descriptive drawing showing one example of the effect determination history information shown in FIG. 6.

FIG. 12 is a sequence drawing showing one example of an initial introduction sequence of a management computer.

FIG. 13A is a descriptive drawing showing an example of an input screen of an operating sequence of a management computer.

FIG. 13B is a descriptive drawing showing a selection example in the setting content addition screen.

FIG. 14 is a descriptive drawing showing an example of an output screen of an operating sequence of a management computer.

FIG. 15 is a flowchart showing an example of operation steps by the management computer.

FIG. 16 is a sequence drawing showing one example of an operation sequence of the management computer.

FIG. 17 is a flow chart showing detailed process steps of the effect confirmation process (step S1602) for the existing setting instance shown in FIG. 16.

FIG. 18 is a flow chart showing detailed process steps of the effect confirmation process (step S1704) during the adding of the setting content shown in FIG. 17.

FIG. 19 is a flow chart showing detailed process steps of the effect confirmation process (step S1805) during the modification of the setting content shown in FIG. 17.

FIG. 20 is a descriptive drawing showing one example of the effect determination information of Embodiment 2.

FIG. 21 is a sequence drawing showing one example of an operation sequence of the management computer of Embodiment 2.

FIG. 22 is a flow chart showing detailed process steps of the effect confirmation process (step S2102) between existing setting instances shown in FIG. 21.

FIG. 23 is a descriptive drawing showing one example of an output screen of Embodiment 2.

### DETAILED DESCRIPTION OF EMBODIMENTS

In a highly reliable infrastructure environment, it is necessary to set up the network without any errors, and to confirm in advance that the settings to be applied are correct prior to modifying the network settings. The present embodiment confirms in advance that the network operation will not be affected by the addition, modification, or deletion of settings in a network having various settings. In this manner, the present embodiment reduces omissions of verification in network settings. In order to do so, the present embodiment relies on the concept of “flow spaces”.

A flow is a packet having common attributes with a group of packets passing through a network device. Examples of attributes include source IP address, destination IP address, and service. Such a group of attributes is referred to as a “flow space”, and a group of values for attributes constituting the flow space is referred to as “flow information”. For example, a group including a source IP address of “10.0.0.5”, and destination IP address of “192.168.0.0.1”, and a service “HTTP (hypertext transfer protocol)” is flow information in a flow space (group including source IP address, destination IP address, and service).

The present embodiment compares flow information in a common flow space between already existing settings on a network and network settings after settings have been added, modified, or deleted to confirm whether or not there are effects from adding, modifying, or deleting network settings. In this manner, the present embodiment reduces omissions of verification in network settings. Details are explained below.

### Embodiment 1

### Example of Overlap Determination Using Flow Space

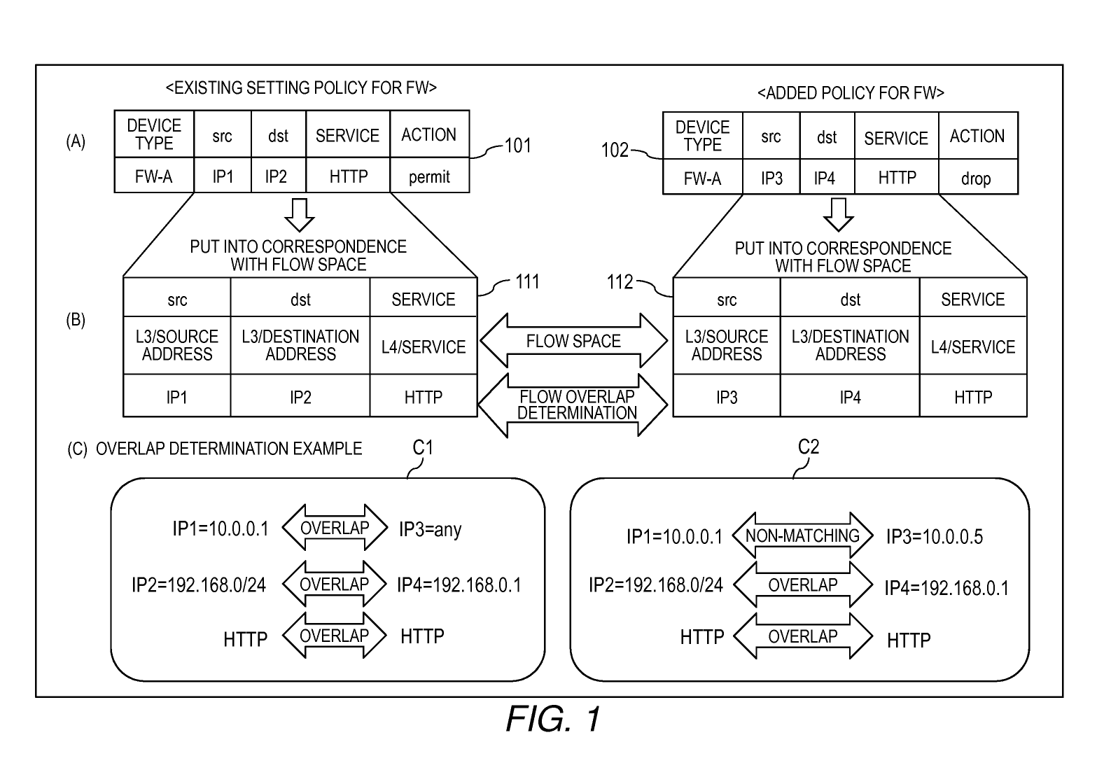

FIG. 1 is a descriptive drawing showing an overlap determination example 1 using a flow space in a case in which settings of a network device are selected. FIG. 1 describes, using an example, a case in which a firewall (FW) “FW-A” is selected as the type of network device. Also, the overlap determination example 1 is described using an example in which the already existing setting items are the same as newly selected setting items.

(A) shows an existing setting policy 101, which includes existing setting items in a firewall, and an added policy 102, which includes selected setting items. The existing setting policy 101 is a policy already set in FW-A. The added policy 102 is a policy added to the existing setting policy. Here, a policy is constituted of the four attributes of source (src), destination (dst), service, and action, for example.

(B) is an example in which the existing setting policy 101 and the added policy 102 are respectively placed in correspondence with flow spaces and intermediate tables 111 and 112 are generated. Specifically, the existing setting policy 101 and the added policy 102 are placed in correspondence with one aspect “L3 (layer 3)/source address” of the flow space, one aspect “L3/destination address” of the flow space, and one aspect “L4 (layer 4)/service” of the flow space. There is no corresponding attribute in the flow space for “action”. Both intermediate tables 111 and 112 share the same flow space, and thus, overlap determination for flow information is executed thereon.

(C) is an example of overlap determination using the intermediate tables 111 and 112 of (B). In the overlap determination examples C1 and C2, portions to the left of the thick arrows are flow information in the intermediate table 111 of the existing setting policy 101, and portions to the right of the thick arrows are flow information in the intermediate table 112 of the added policy 102.

In the overlap determination example C1, IP1=10.0.0.1 and IP3=any are compared in the “L3/source address”. Since “any” means that any address can be used, this results in overlap between IP1 and IP3. Also, in “L3/destination address”, IP2=192.168.0/24 is compared to IP4=192.168.0.1. Since “192.168.0/24” includes “192.168.0.1”, this means an overlap between IP2 and IP4. Also, “L4 (layer 4)/service” is HTTP for both intermediate tables, and thus, there is an overlap. Also, “L4 (layer 4)/service” not only includes well-known protocols such as HTTP, but also includes port numbers or a range of port numbers. An example is “TCP:12345” or “TCP:12345-12348”. If the port numbers are specified in terms of range, then the overlap determination result returns “overlap” if the ranges completely match or overlap in part.

In this manner, if all attributes compared in the flow space are determined to overlap, then it is determined that the existing setting policy 101 and the added policy 102 overlap. Thus, the overlap determination example C1 determines that the addition of the added policy 102 to the existing setting policy 101 would affect already existing network settings.

The overlap determination example C2 is an example in which IP3 of the overlap determination example C1 is modified from “any” to “10.0.0.5”. In this case, under “L3/source address”, IP=10.0.0.1 is compared with IP3=10.0.0.5, and there is no overlap here. In this manner, if any attributes compared in the flow space are determined not to overlap, then it is determined that the existing setting policy 101 and the addition policy 102 do not overlap. Thus, the overlap determination example C2 determines that the addition of the added policy 102 to the existing setting policy 101 would not affect already existing network settings.

In this matter, if setting items are the same, then it is possible to map flow information of items of both policies onto a flow space and compare them to determine whether or not there is an overlap in the flow space, and it is possible to confirm whether or not new selection of setting items has an effect on existing network settings.

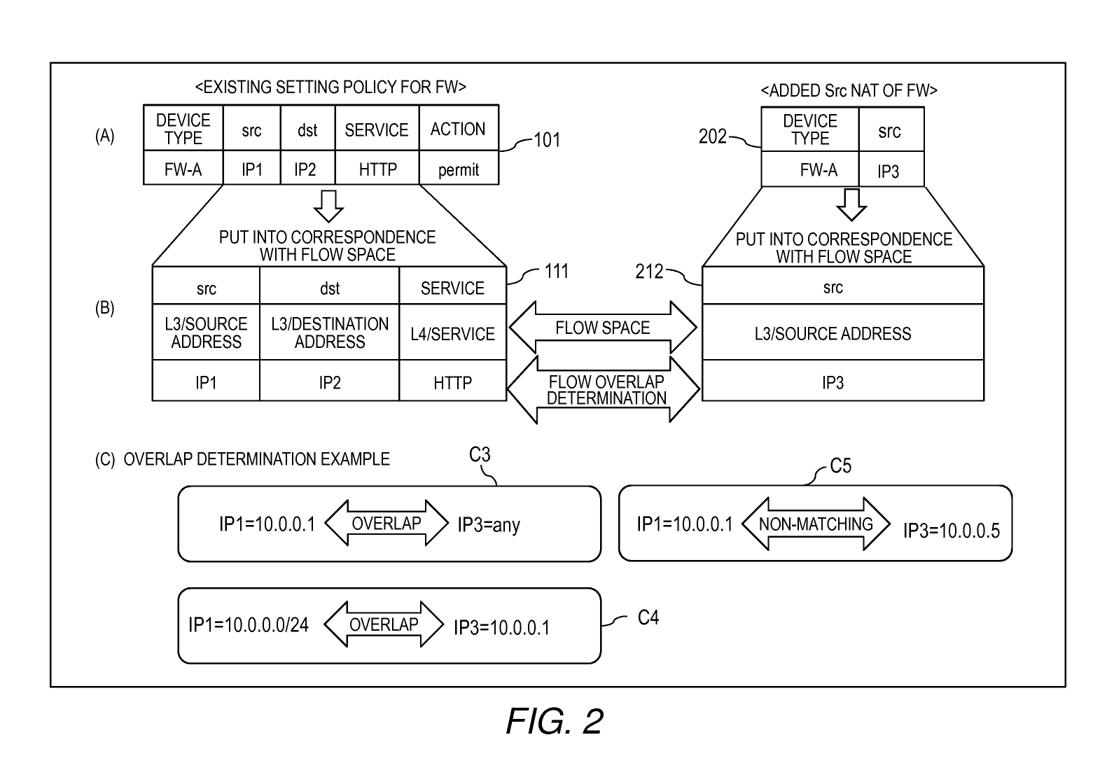

FIG. 2 is a descriptive drawing showing an overlap determination example 2 using a flow space in a case in which settings of a network device are selected. Like FIG. 1, FIG. 2 describes, using an example, a case in which a firewall (FW) “FW-A” is selected as the type of network device. Also, in the overlap determination example 2 is described using an example in which the existing setting items are different from newly selected setting items.

(A) shows an existing setting policy 101, which includes existing setting items in the firewall, and an added Src/network address translation (NAT) 202, which includes selected setting items. Similar to FIG. 1, the existing setting policy 101 is a policy already set in FW-A. The added Src/NAT 202 is a newly added network address modification process for the source address. The Src/NAT is constituted of one attribute: destination (dst).

(B) is an example in which the existing setting policy 101 and the Src/NAT 202 are respectively placed in correspondence with flow spaces and intermediate tables 111 and 212 are generated. Specifically, the existing setting policy 101 and the added policy 102 are placed in correspondence with one aspect “L3 (layer 3)/source address” of the flow space, one aspect “L3/destination address” of the flow space, and one aspect “L4 (layer 4)/service” of the flow space. There is no corresponding attribute in the flow space for “action”. The flow space of both intermediate tables 111 and 112 has in common “L3 (layer 3)/source address”, and thus, it is determined that there is an overlap in flow information here.

(C) is an example of overlap determination used on the intermediate tables 111 and 212. In the overlap determination examples C3 to C5, portions to the left of the thick arrows are flow information in the intermediate table 111 of the existing setting policy 101, and portions to the right of the thick arrows are flow information in the intermediate table 212 of the Src/NAT 202.

The overlap determination example C3 compares IP1=10.0.0.1 and IP3=any, which are “L3/source addresses”. Since “any” means that any address can be used, this results in overlap between IP1 and IP3. The overlap determination example C4 compares IP1=10.0.0.0/24 and IP3=10.0.0.1, which are “L3/source addresses”. Since “10.0.0.0/24” includes “10.0.0.1”, this means an overlap between IP1 and IP3. The overlap determination example C5 compares IP1=10.0.0.1 and IP3=10.0.0.5, which are “L3/source addresses”. Because “10.0.0.1” and “10.0.0.5” are different addresses, it is found that there is no overlap.

If all attributes compared in the flow space are determined to overlap, then it is determined that the existing setting policy 101 and the Src/NAT 202 overlap. Thus, the overlap determination examples C3 and C4 determine that there would be an effect on existing network settings. Also, if any attributes compared in the flow space are determined not to overlap, then it is determined that the existing setting policy 101 and the Src/NAT 202 do not overlap. Thus, the overlap determination example C5 determines that there would not be an effect on existing network settings.

In this matter, even if setting items are different, it is possible to map flow information of items of both policies onto a flow space and compare them to determine whether or not there is an overlap in the flow space, and it is possible to confirm whether or not new selection of setting items has an effect on existing network settings.

In FIG. 2, a policy with existing setting items and Src/NAT with newly selected setting items were given as examples, but Src/NAT may be used for existing setting items, and the policy may be used for newly selected setting items.

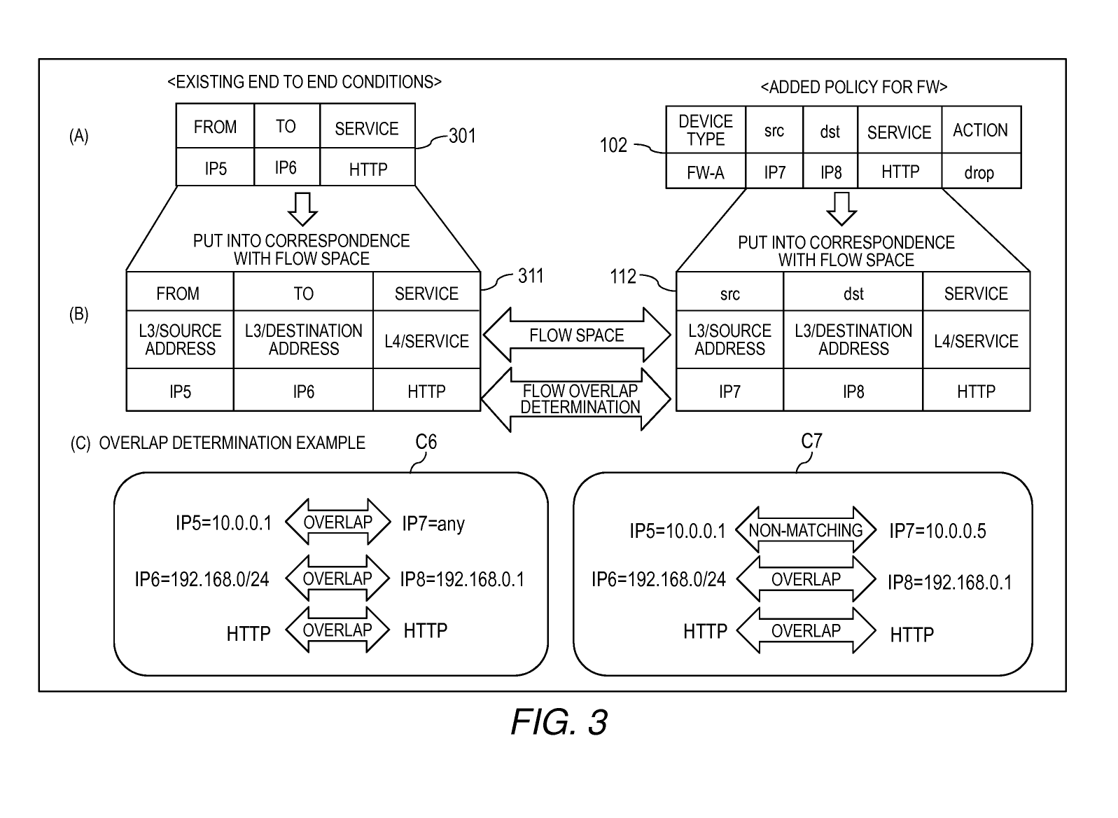

FIG. 3 is a descriptive drawing showing an overlap determination example 3 using a flow space having end to end conditions. In the overlap determination example 3, a description is made of a case in which a firewall policy is added as a setting item, for example, when there are existing end to end conditions. The content of FIG. 3 will be used for the existing end to end conditions and the content of FIG. 1 will be used for the added policy 102. The end to end conditions define whether or not communication from end to end is possible. More specifically, the end to end conditions include the host name or IP address of the source end, the host name or IP address of the destination end, the service, and actions for such communication (whether or not communication is possible, packet conversion, etc.). Packet conversion such as load balancing and NAT is not essential. Also, the end to end conditions do not include settings for individual network devices.

(A) shows existing end to end conditions 301 and an added policy 102. (B) is an example in which the existing end to end conditions 301 and the added policy 102 are respectively placed in correspondence with flow spaces and intermediate tables 311 and 112 are generated. The flow space obtained from the existing end to end conditions 301 is a combination of “L3 (layer 3)/source address”, “L3/destination address”, and “L4 (layer 4)/service”. The flow space obtained from the added policy 102 is also a combination of “L3 (layer 3)/source address”, “L3/destination address”, and “L4 (layer 4)/service”. Both intermediate tables share the same flow space, and thus, overlap determination for flow information is executed thereon.

(C) is an example of overlap determination used on the intermediate tables 311 and 112. In the overlap determination examples C6 and C7, portions to the left of the thick arrows are flow information in the intermediate table 311 of the existing end to end conditions 301, and portions to the right of the thick arrows are flow information in the intermediate table 112 of the added policy 102. If all attributes compared in the flow space are determined to overlap, then it is determined that the existing end to end conditions 301 and the added policy 102 overlap. On the other hand, if any of the attributes compared in the flow space are determined not to overlap, then it is determined that the existing end to end conditions 301 and the added policy 102 do not overlap.

The content of the overlap determination example C6 is the same as that of the overlap determination example C1 shown in FIG. 1, and thus, descriptions thereof are omitted. In the overlap determination example C6, all attributes compared in the flow space are determined to overlap, and thus, it is determined that the existing end to end conditions 301 and the added policy 102 overlap. Thus, the overlap determination example C6 determines that there would be an effect on existing network settings.

The content of the overlap determination example C7 is the same as that of the overlap determination example C2 shown in FIG. 1, and thus, descriptions thereof are omitted. In the overlap determination example C7, the attributes “L3/source address” in the flow space are determined not to overlap, and thus, it is determined that the existing end to end conditions 301 and the added policy 102 do not overlap. Thus, the overlap determination example C7 determines that there would not be an effect on existing network settings.

In this matter, even when comparing the end to end conditions 301 with differing setting items (added policy 102), it is possible to map flow information of items of both the end to end conditions and the setting items onto a flow space and compare them to determine whether or not there is an overlap in the flow space, and it is possible to confirm whether or not there is an effect on existing network settings.

In FIG. 3, an example was described in which overlap determination is performed between the existing end to end conditions 301 and newly selected setting items (the added policy 102, for example), but overlap determination may be performed on existing setting items (the added policy 102, for example) and newly selected end to end conditions 301.

In FIGS. 1 to 3, an example was described of a case in which either the setting content or the end to end conditions are added, with a case in which the setting content or end to end conditions are newly selected as an example, but actions are not limited to additions, and the aforementioned also applies to modifications. In FIGS. 1 to 3, overlap determination examples using a flow space were described, but the effect on existing instances may be confirmed according to, for example, the size of an “order” value indicating the order of priority of a policy or whether or not IP addresses in a mapped IP (MIP) are the same.

### Network Configuration Example

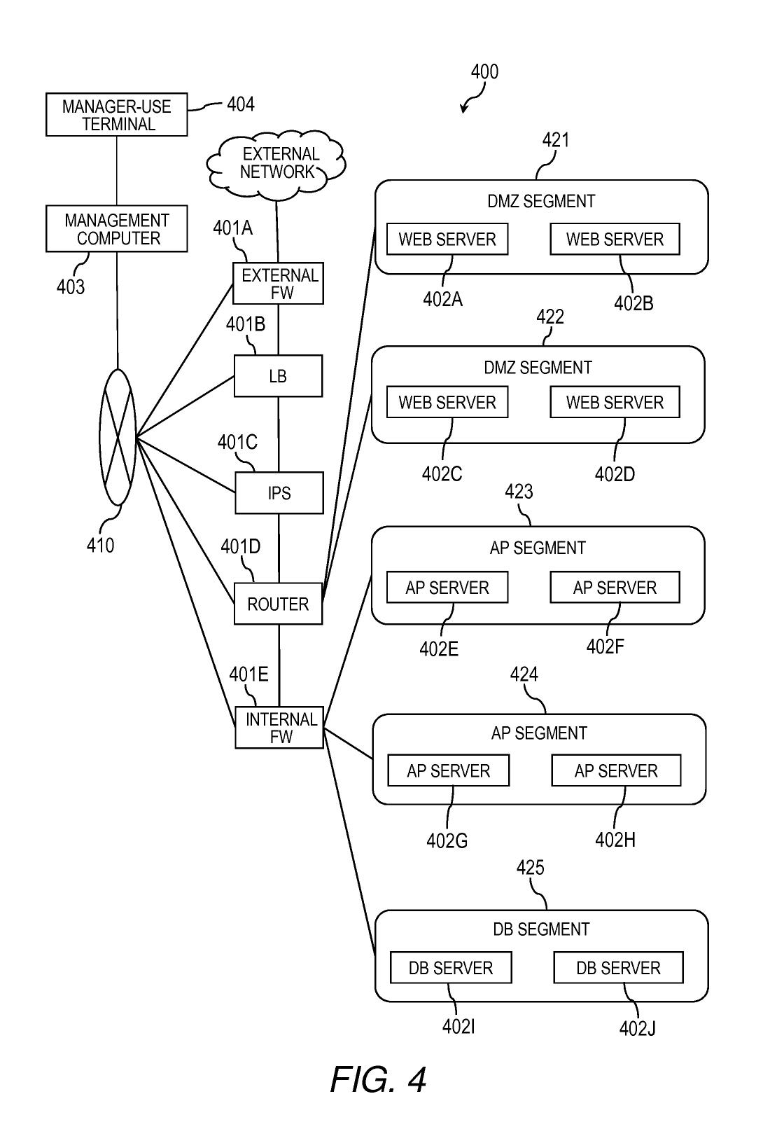

FIG. 4 is a block diagram showing a system configuration example for a network system of Embodiment 1. A network system 400 has network devices 401A to 401E (hereinafter collectively referred to as “network devices 401”), computers 402A to 402J (hereinafter collectively referred to as “computers 402”), and a management computer 403.

The network devices 401 include an external FW 401A, a load balancer (LB) 401B, an intrusion prevention system (IPS) 401C, a router 401D, an internal FW 401E, and the like, for example. The network devices 401 may further include a switch, a Virtual Private Network (VPN) device, and an Intrusion Detection System (IDS).

The computers 402 include web servers 402A to 402D, application (AP) servers 402E to 402H, database (DB) servers 402I and 402J, and the like, for example. The computers 402 respectively belong to segments. The segments include demilitarized zone (DMZ) segments 421 and 422, AP segments 423 and 424, and a DB segment 425, for example. The web servers 402A to 402D belong to the DMZ segments 421 and 422, the AP servers 402E to 402H belong the AP segments 423 and 424, and the DB servers 402I and 402J belong to the DB segment 425. The management computer 403 can be operating by a manager-use terminal 404, for example.

The management computer 403 verifies effects of settings inputted from the manager-use terminal 404 and already existing network settings. The management computer 403 then collects settings and configuration data aimed at the network devices 401 through a managing network 410. The manager-use terminal 404 provides a user interface for operating the management computer 403.

### Hardware Configuration Example

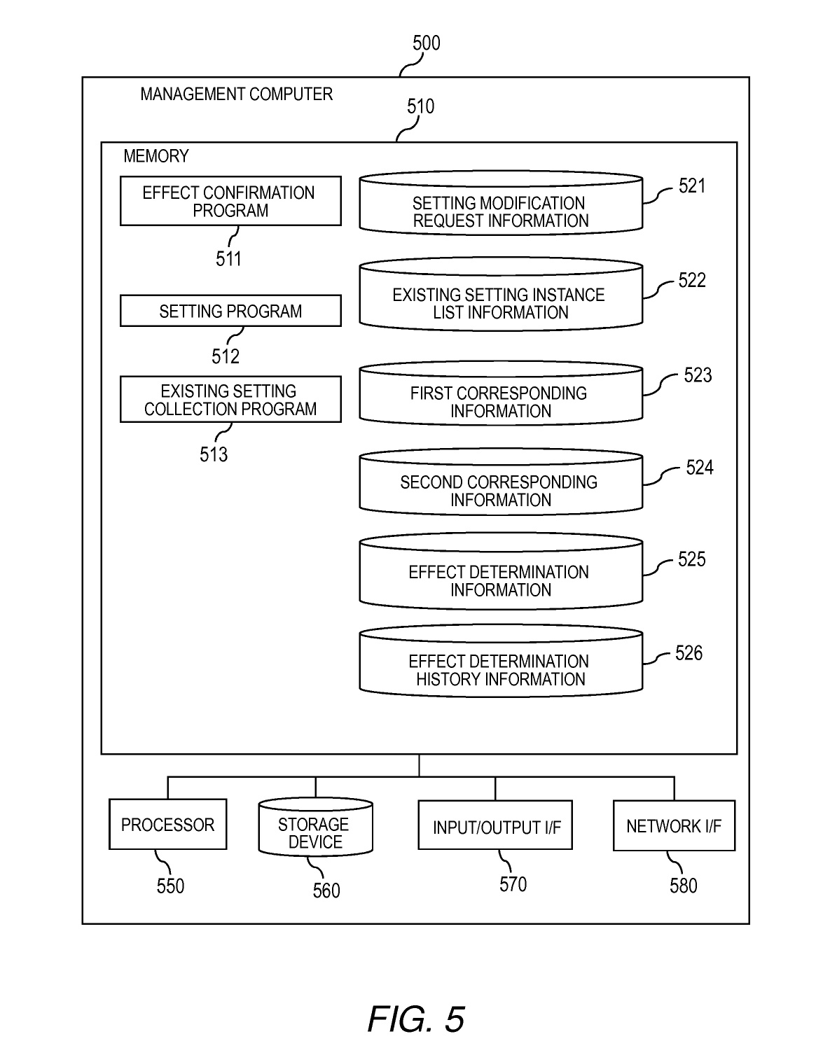

FIG. 5 is a block diagram showing a hardware configuration example of the management computer 403. The management computer 403 has a processor 550, a memory 510, a storage device 560, an input/output interface (I/F) 570, and a network interface (I/F) 580.

The management computer 403 transmits and receives information through other devices coupled to the network such as the network devices 401 and the network I/F 580. The processor 550 executes programs stored in the memory 510. The memory 510 stores programs to be executed by the processor 550 and information necessary to execute such programs. Specifically, the memory 510 stores an effect confirmation program 511, a setting program 512, and an existing setting collection program 513. The memory 510 also stores setting modification request information 521, existing setting instance list information 522, first correspondence information 523, second correspondence information 524, setting content/setting instance effect determination information 525, and effect determination history information 526.

Also, the effect confirmation program 511, the setting program 512, and the existing setting collection program 513 may be stored in a non-temporary storage medium such as the storage device 560. In such a case, the processor 550 reads in the programs 511 to 513 from the storage device 560, loads the read-in programs 511 to 513 on the memory 510, and executes the loaded programs 511 to 513.

Information such as tables stored in the memory 510 can be stored in a storage device such as the storage device 560, a non-volatile semiconductor memory, a hard disk drive, or a solid state drive (SSD), or in a computer-readable non-temporary data storage medium such as an IC card, an SD card, or a DVD. Below, the programs and information stored in the memory 510 will be described.

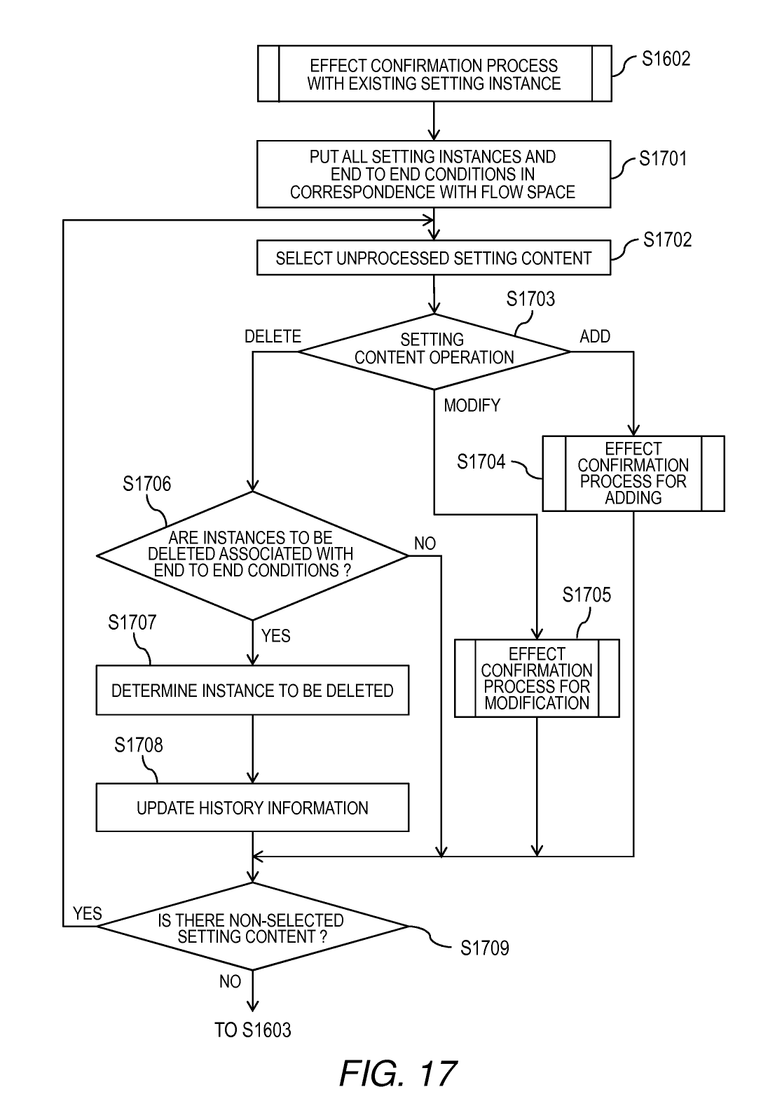

The effect confirmation program 511 is a program for confirming the effect between setting modification content and setting instances, which are network setting items that have already been set. The process conducted by the effect confirmation program 511 will be described with reference to FIG. 17.

The setting program 512 is a program for converting requested setting modification content to the network device 401 to which the settings are to be applied and applying the setting command to the network device 401. The setting command may alternatively apply settings to the network device 401 through a setting means such as an application programming interface (API).

The existing setting collection program 513 is a program for collecting existing setting information from the network devices 401 and storing it in the existing setting instance list information 522.

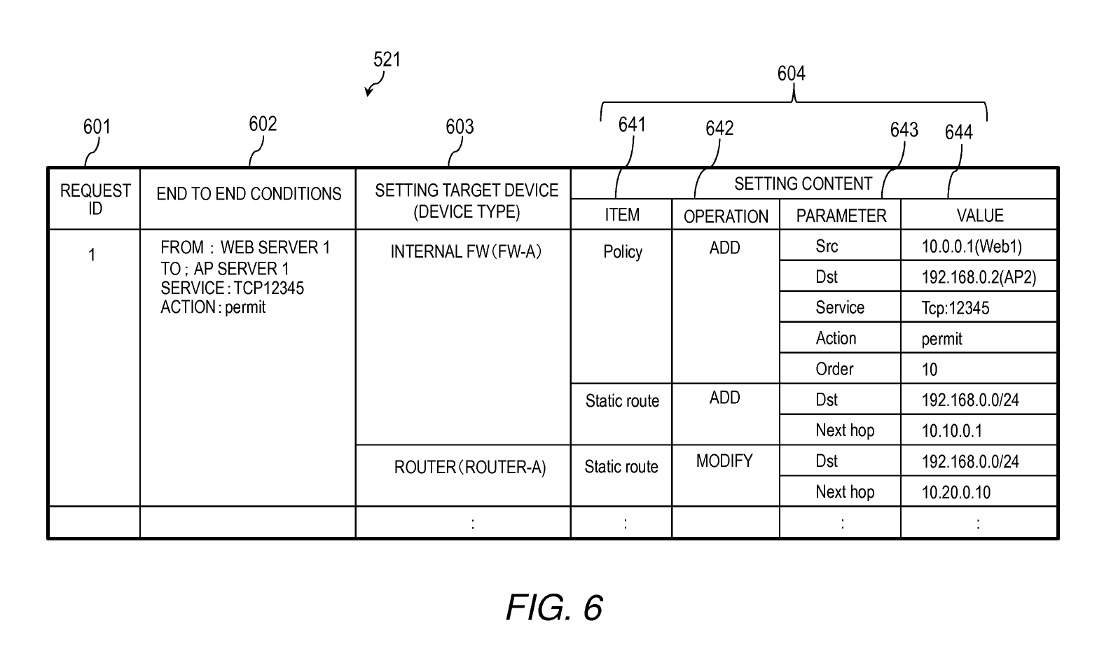

The setting modification request information 521 is information storing setting modification requests received from the manager-use terminal 404. Specifically, the setting modification request information 521 includes end to end conditions and individual settings for achieving such end to end conditions, for example. The setting modification request information 521 will be described later with reference to FIG. 6.

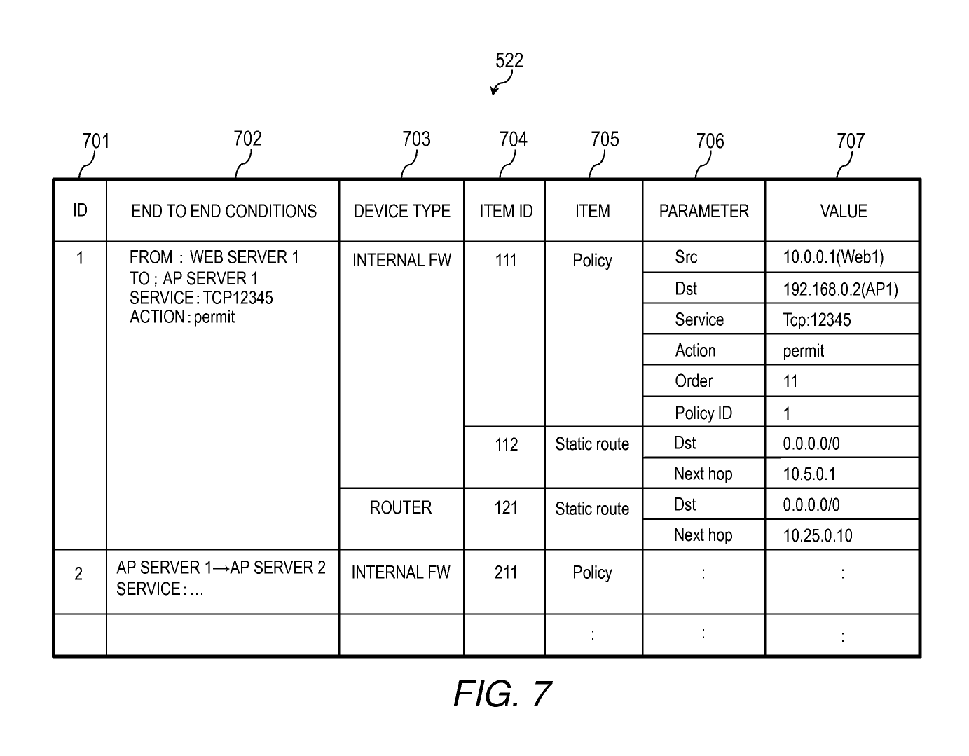

The existing setting instance list information 522 is information storing existing setting instances, which are information already set in the network device 401. The existing setting instance list information 522 will be described later with reference to FIG. 7.

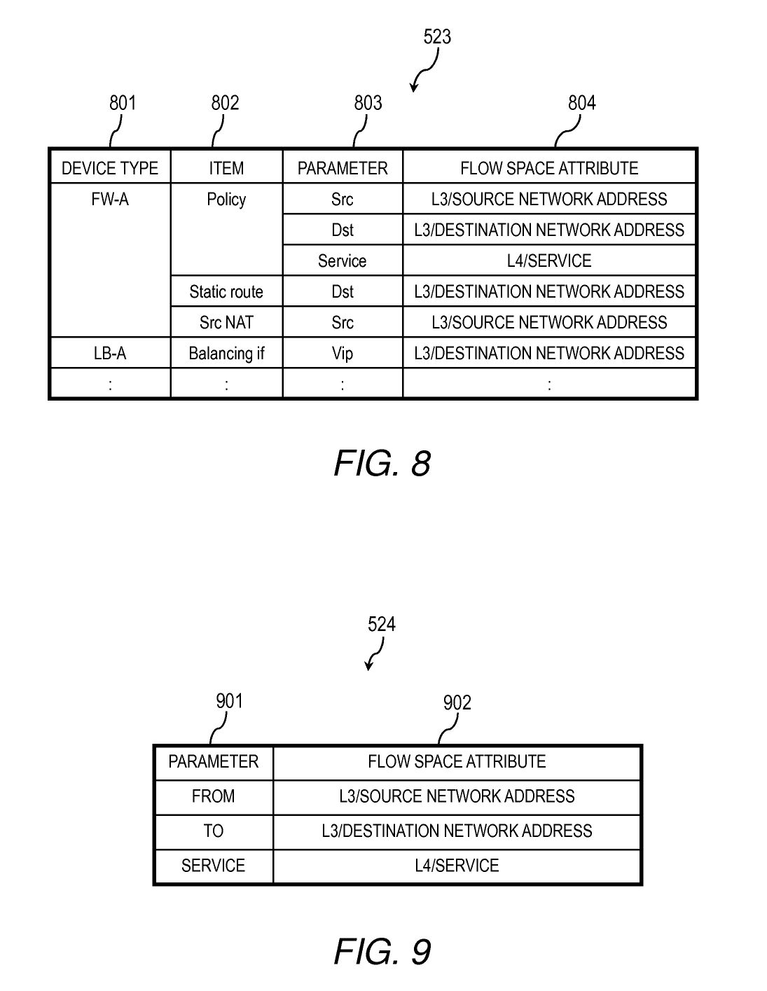

The first correspondence information 523 is information for placing flow information included in the requested setting modification content and the existing setting instances in correspondence with the flow space. The first correspondence information 523 to the flow space will be described later with reference to FIG. 8.

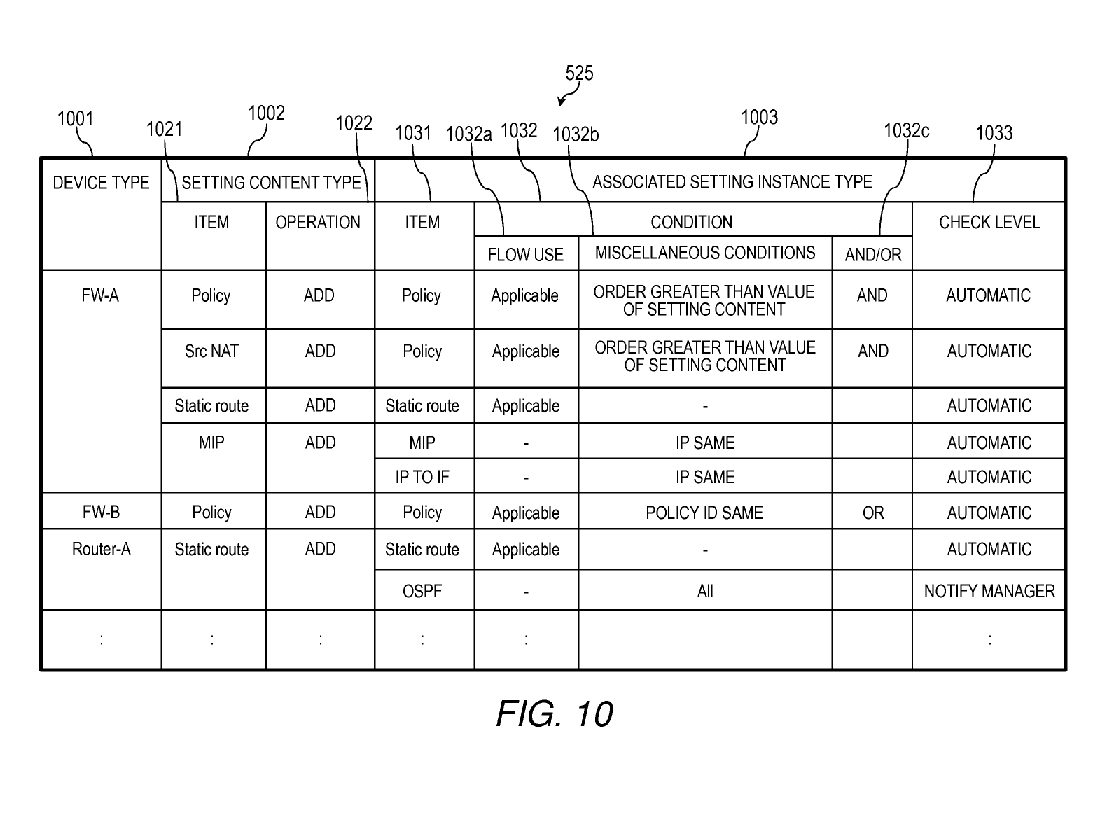

The second correspondence information 524 is information for placing end to end conditions included in the requested setting modification content and the existing setting instances in correspondence with the flow space. The second correspondence information 524 will be described later with reference to FIG. 9.

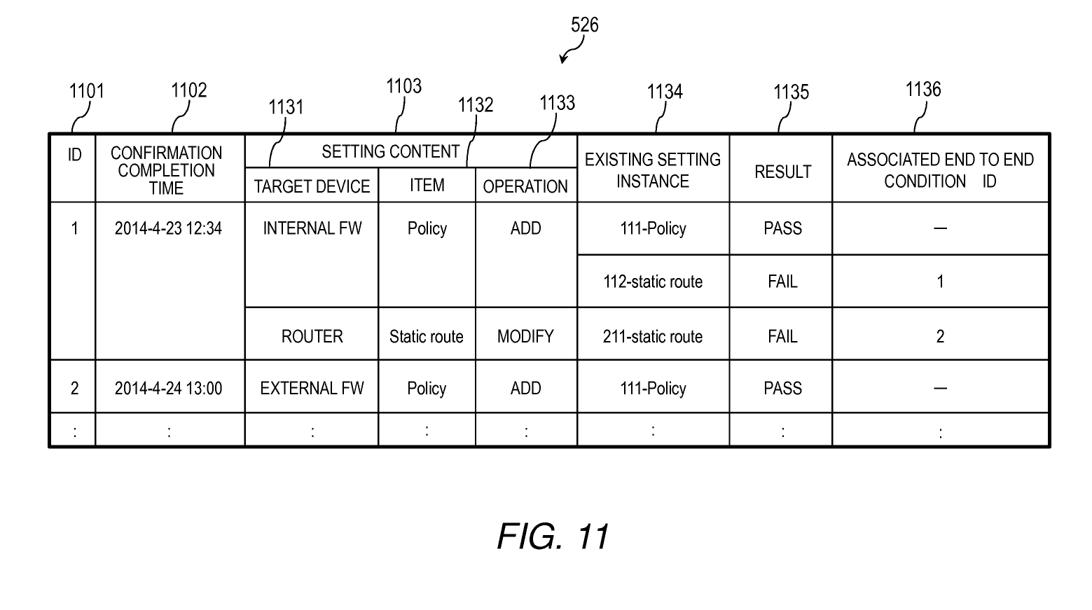

The effect determination information 525 is information for placing the type of setting instance associated with setting content in correspondence with affecting conditions. The effect determination information 525 will be described later with reference to FIG. 10.

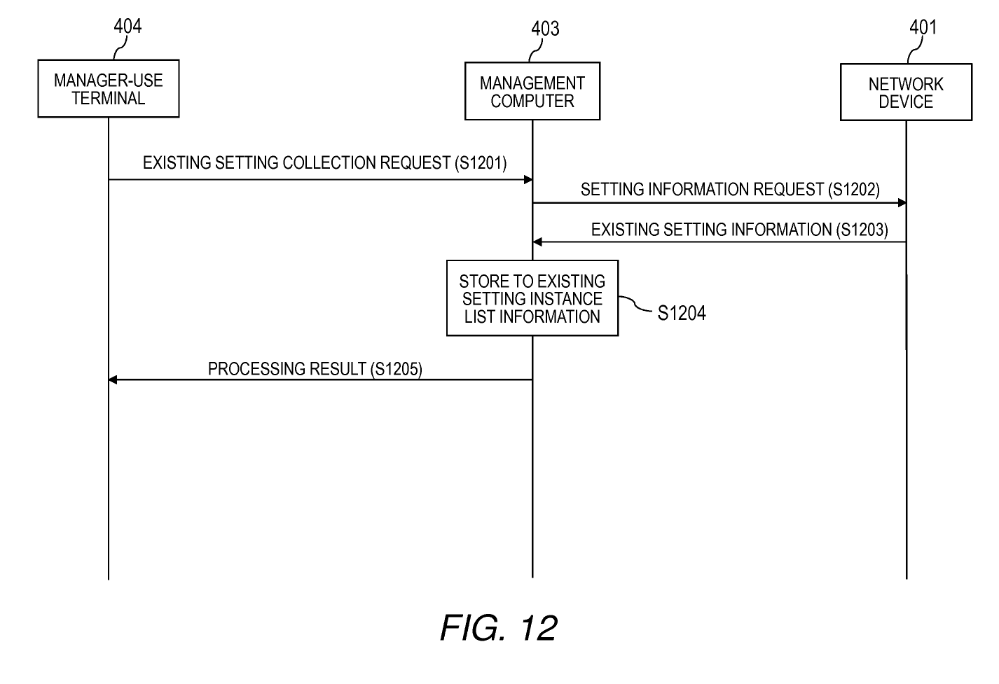

The effect determination history information 526 is information storing history information 526 of effects determined by the effect confirmation program 511. The effect determination history information 526 will be described later with reference to FIG. 11.

### Information in Memory 510

Next, respective information in the memory 510 shown in FIG. 5 will be described. In the description below, the information in the memory 510 is stored in table format, but the information need not necessarily be expressed in a table-based data structure, and may instead be expressed as a data structure such as a list, DB, or a queue. In order to express the fact that the type of data structure does not matter, the word “information” may be used for “tables”, “lists”, “DBs”, “queues”, and the like. When describing the content of the information, it is possible to use the terms “identification information”, “identifier”, “name”, and “ID”, and these terms are interchangeable. Also, “OO field aaa” (aaa being a reference character) is sometimes abbreviated as “OO aaa”.

FIG. 6 is a descriptive drawing showing one example of the setting modification request information 521 shown in FIG. 5. The setting modification request information 521 is information storing setting modification requests received from the manager-use terminal 404. The setting modification request information 521 has a request ID field 601, an end to end condition field 602, a setting target device (device type) field 603, and a setting content field 604.

The request ID field 601 is a field into which request IDs are stored. The request ID is identification information for giving a unique identifier to an inputted setting modification request. The end to end condition field 602 is a field for storing end to end conditions included in the inputted setting modification request. If no end to end conditions are included in the setting modification request, then no end to end request is stored in the end to end request field 602.

The setting target device (device type) field 603 is a field for storing the setting target device (device type). The setting target device (device type) is information for identifying the network device 401 to which settings are to be applied and the device type to which the network device 401 belongs. The setting content field 604 is a field into which setting content is stored. The setting content is defined by an item field 641, an operation field 642, a parameter field 643, and a value field 644.

The item field 641 is a field for storing items indicating the type of setting content. Items include, for example, the policy, static route, Src/NAT, and balancing IF of an FW.

The operation field 642 is a field for storing information the type of operations in network settings (that is, items that are values of the item field 641). Operations include “add”, “modify”, or “delete”, for example. “Add” refers to newly applying the item 641 indicating the type of settings and the value 644 of the parameter 643 thereof to the network. “Modify” refers to modifying the value 644 of the parameter 643 of the item 641 indicating the type of settings in an existing setting instance. “Delete” refers to deleting the already existing instance. The setting instance to be modified or deleted is defined by the value of the value field 644.

The parameter field 643 is a field into which parameters are stored. Parameters are information to be operated on according to the setting item 641. If, for example, the item 641 of the setting content 604 is “policy”, then the parameter 643 becomes “Src”, “Dst”, “service”, “action”, and “order”.

The value field 644 is a field into which values indicated by the parameter 641 are stored. The value depends on the parameter 643. If, for example, the parameter 643 is “Src”, “Dest”, or “Next/hoP”, then the value 644 becomes the address thereof. If the parameter 643 is “service”, then the value 644 becomes the protocol number signifying the communication service. If the parameter 643 is “action”, then the value 644 becomes “permit” or “drop”, which are possible operations of the device to which the settings are to be applied. If the parameter 643 is “order”, then the value 644 becomes a number indicating order of priority. In this manner, it is possible to set the item 641, the operation 642, the parameter 643, and the value 644 in the setting content field 604. Thus, it is possible to handle various types of setting content.

FIG. 7 is a descriptive drawing showing one example of the existing setting instance list information 522 shown in FIG. 5. The existing setting instance list information 522 is information storing existing setting instances, which are information already set in the network device 401. The existing setting instance list information 522 has an ID field 701, an end to end condition field 702, a device type field 703, an item ID field 704, an item field 705, a parameter field 706, and a value field 707.

The ID field 701 is a field into which IDs are stored. IDs are identification information uniquely identifying an existing setting instance. The end to end condition field 702 is a field for storing end to end conditions of an existing setting instance. The end to end conditions include information identifying the source (the web server 1, for example), information identifying the destination (the AP server 1, for example), and information identifying the service (TCP12345, for example).

There are also existing setting instances with no end to end conditions. In such a case, “-” (no associated end to end conditions) is stored as the value for the end to end condition field.

The device type field 703 is a field for storing information identifying the type of device. The type of device indicates the type of network device 401 set in the existing setting instance.

The item ID field 704 is a field into which item IDs are stored. The item ID is identification information uniquely identifying setting content items for existing setting instances. The item field 705 is a field for storing items identified by the item ID 704. Items are information uniquely identifying the setting content of an existing setting instance. The parameter field 706 is a field into which parameters are stored. The parameter is information handled by the item 705 identified by the item ID 704.

FIG. 8 is a descriptive drawing showing one example of the first correspondence information 523 shown in FIG. 5. The first correspondence information 523 is information for placing flow information included in the requested setting modification content and the existing setting instances in correspondence with the flow space. The first correspondence information 523 is information set in advance. The first correspondence information 523 has a device type field 801, an item field 802, a parameter field 803, and a flow space attribute field 804.

The device type field 801 is a field for storing the device type of the network device 401. The item 802 and the parameter 803 determining the flow differ depending on the device type, and thus, entries for the first correspondence information 523 are set for each device type. The item field 802 is a field for storing items indicating the type of setting content set for the device type 801.

The parameter field 803 is a field into which parameters are stored. The parameter is flow information handled by the item 802. If, for example, the item 802 is “policy”, then the parameter 803 is “Src”, “Dst”, and “service”. “Action” and “order” are not flow information, and therefore not included.

The attribute field 804 of the flow space is a field for storing flow space attributes shown in FIGS. 1 to 3. As a result, the first correspondence information 523 places the parameters 803 of differing items 802 in correspondence with attributes in the flow space. This causes the management computer 403 to confirm the presence or absence of effects on network settings using flow information even among different items.

FIG. 9 is a descriptive drawing showing one example of the second correspondence information 524 shown in FIG. 5. The second correspondence information 524 is information for placing end to end conditions included in the existing setting instances in correspondence with the flow space. The second correspondence information 524 is information set in advance. The second correspondence information 524 has a parameter field 901 and a flow space attribute field 902.

The parameter field 901 is a field into which parameters are stored. The parameter is flow information defined by the end to end conditions 702. The “from”, “to”, and “service” of the end to end conditions 702 belong to the parameter 901, for example.

The attribute field 804 of the flow space is a field for storing flow space attributes shown in FIG. 3. As a result, the second correspondence information 524 places the end to end conditions and parameters included in the existing setting instance in correspondence with the attributes in the flow space. This causes the management computer 403 to confirm the presence or absence of effects on network settings by also using flow information between the end to end conditions and item parameters included in the existing setting instance.

FIG. 10 is a descriptive drawing showing one example of the effect determination information 525 shown in FIG. 5. The effect determination information 525 is information for determining the effect between the setting content and the setting instance. The effect determination information 525 defines conditions for determining effects by operations of the network device 401. The conditions for determining the effect of operations by a network device 401 are applied to the combination of setting items to be applied to the network device 401. The conditions for determining the effect of operations of a network device 401 are the type of already existing setting instances affected by the respective setting content items (setting items) and the conditions that result in effects. There are no effects between various types of setting content where there is overlap in the flow to be controlled and the setting instances, and thus, the combination of setting content having effects and setting instances is defined.

Specifically, the effect determination information 525 has a device type field 1001, a setting content type field 1002, and an associated setting instance type field 1003, for example. The device type field 1001 is a field into which device types are stored. The device type is the type of network device 401.

The setting content type field 1002 is a field into which the setting content type is stored. The setting content type field 1002 has an item field 1021 and an operation field 1022, and defines the setting content type by the combination of items, which are values of the item field 1021, and the operations (add, modify, delete), which are values of the operation field 1022.

The associated setting instance type field 1003 is a field in which associated setting instance types are stored. The associated setting instance type field 1003 has an item field 1031, a condition field 1032, and a check level field 1033, and the type of setting instance (associated setting instance type) that has an effect on the setting content type is defined by the values of the fields 1031 to 1033.

Specifically, the item field 1031 is a field into which items, which are setting content applied to already configured instances, are stored. The condition field 1032 has a flow-use field 1032a, a miscellaneous condition field 1032b, and an AND/OR field 1032c, and the values of these fields 1032a to 1032c define conditions affecting the already configured instances.

The flow-use field 1032a is a field for storing information indicating whether or not the flow is to be used. Flow-use is one condition having an effect on the setting content type. If the flow is to be used, then “applicable” is stored, and if the flow is not to be used, then “-” is stored. If the flow is to be used, then overlap determination of flow information for the items of the setting instance defined by the values of the item field 1031 is executed.

The miscellaneous condition field 1032b is a field where miscellaneous conditions are stored. The miscellaneous conditions are conditions having an effect on the setting content type other than what is to be used in the flow. Conditions such as “order being greater than setting content value”, “IP” being the same, and “policy” being the same, based on the setting instance items identified by the value of the item field 1031, are set. If the “order is greater than the setting content value”, then if the setting instance order value in the “order” parameter indicating the order in which the firewall policy is to be applied is greater than the value of the setting content order, then the setting content is applied before the existing setting instance, and thus, this is a condition having an effect on the existing setting instance.

The AND/OR field 1032c is a field for defining whether the conditions affecting the instance are the flow-use and a miscellaneous condition (AND), or the flow-use or another condition (OR). In the case of AND, if both the flow-use and the miscellaneous condition are satisfied, then this means that there is an effect between the setting content and the setting instance. In the case of OR, if both the flow-use and/or the miscellaneous condition are satisfied, then this means that there is an effect between the setting content and the setting instance.

The check level field 1033 is a field for storing the check level. The check level is a check method for a condition 1032b having an effect on an instance. If “automatic”, then the checking is performed automatically according to the condition 1032b affecting the instance. If the check level is “notify manager”, then the checking is performed automatically and the check result is outputted to a display screen according to the condition 1032b affecting the instance.

Regarding the condition 1032 affecting the instance, if there is an overlap in the flow to be controlled in the network, then there are many cases in which either the existing settings or the new settings do not operate as expected and an effect is present. Thus, it is possible to automatically perform an overlap check for flow information by setting the value of the flow-use field 1032a to “available” without defining conditions between individual parameters.

Also, “notify the manager” is set for complex cases in which it is not possible to determine the presence or absence of effects simply by the condition 1032 affecting the instance. In such a case, the condition 1032 affecting the instance is used to confirm the possibility or lack thereof of effects in a manner similar to “automatic”, and if there is a possibility of effects, the manager is notified, and the manager makes the final decision. Although the final decision is not automatically made, by extracting the combination for which effects are possible, it is possible to prevent omission of checks.

FIG. 11 is a descriptive drawing showing one example of the effect determination history information 526 shown in FIG. 6. The effect determination history information 526 is information storing history information 526 of effects determined by the effect confirmation program 511. The effect determination history information 526 has an ID field 1101, a confirmation completion time field 1102, a setting content field 1103, an existing setting instance field 1104, a result field 1105, and an associated end to end condition ID field 1106.

The ID field 1101 is a field in which an ID uniquely identifying the effect determination history is stored. The confirmation completion time field 1102 is a field storing the date and time at which confirmation was completed. The date and time at which confirmation was completed is the date and time at which the effect determination process was completed.

The setting content field 1103 is constituted of a target device field 1131, an item field 1132, and an operation field 1133. The target device field 1131 is a field storing information identifying the target device. The target device is a network device 401 set according to the item 1132 of the setting content 1103. The item field 1132 is a field storing items of the setting content 1103 set for the target device 1131. The operation field 1133 is a field storing operation types (add, modify, or delete) of the item 1132 of the setting content 1103 set for the target device 1131.

The existing setting instance field 1134 is a field storing information indicating the existing setting instance for which the effects thereof are to be confirmed. The result field 1135 is a field storing the confirmation results for whether or not there are effects. “Pass” means there are no effects and “fail” means that there are effects.

The associated end to end condition ID field 1136 is a field storing the ID 701 of end to end conditions 702 associated with an existing setting instance. If the result 1135 is “fail”, or in other words, there is an effect, then an end to end conditions 702 are useful as a reference for when the manager considers options to handle the situation. Thus, the associated end to end conditions 702 are defined, and the ID 701 thereof is stored. This process is performed only when the result 1135 is a “fail”.

### Initial Introduction Sequence of Management Computer 403

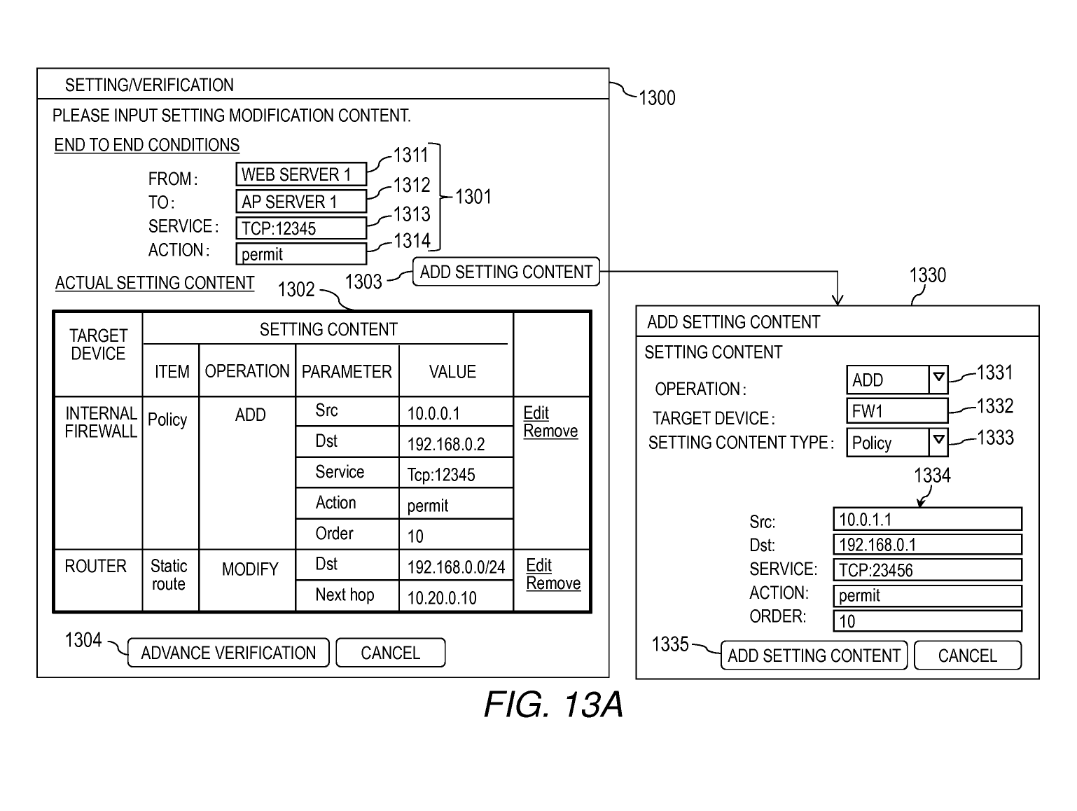

FIG. 12 is a sequence drawing showing one example of an initial introduction sequence of a management computer 403. When the existing setting instance list information 522 in the management computer 403 and the information in the actual network do not match, the sequence may be executed in order to cause the existing setting instance information in the management computer 403 to match the information in the actual network.

First, the manager-use terminal 404 sends an existing setting gathering request to the management computer 403 (step S1201). When the management computer 403 receives the existing setting gathering request, it sends a setting information request to each network device 401 (step S1202). When the network device 401 receives the setting information request, it sends the setting information thereof to the management computer 403 (step S1203).

Specifically, the management computer 403 logs in to the network device 401 through Telnet or Secure Shell (SSH), and obtains the configs, which are setting information. The configs may alternatively be obtained through Simple Network Management Protocol (SNMP) or Network Configuration Protocol (NETCONF). The management computer 403 stores the setting information gathered from the network devices 401 as existing setting instance list information 522 (step S1204). Specifically, the management computer 403 stores the value of parameters of each type of item in a value field, for example. The management computer 403 sends to the manager-use terminal 404 a result stating to the effect that the existing setting gathering has been completed (step S1205).

### Operating Sequence of Management Computer 403

Next, the operating sequence of the management computer 403 will be described. The sequence specifically confirms whether the setting content is correct and then actually applies the settings to the network device 401 when performing a setting modification operation during operation of the network system 400.

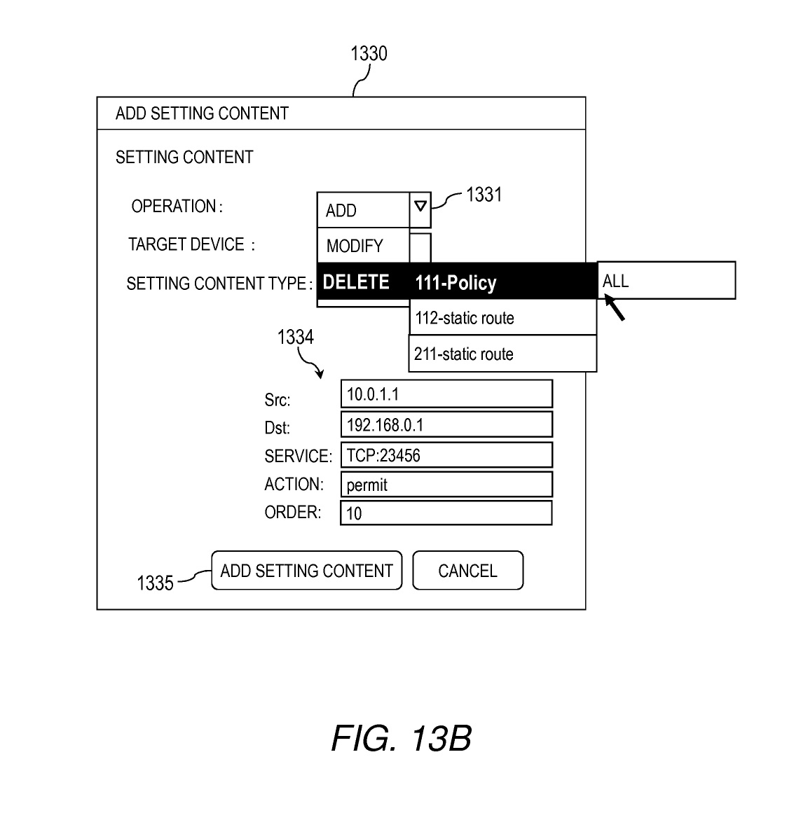

FIG. 13A is a descriptive drawing showing an example of an input screen of an operating sequence of a management computer 403. The input screen is displayed in the display device of the manager-use terminal 404. The input screen 1300 displays an input region 1301 for the end to end conditions, a display region 1302 displaying actual setting content, a setting content addition button 1303, and an advance verification button 1304.

The input region 1301 has a “from” input field 1311 for inputting the source of the end to end conditions, a “to” input field 1311 for inputting the destination of the end to end conditions, a service input field 1313 for inputting the service contents of the end to end conditions, and an action input field 1414 for inputting the operation content. The manager inputs values to the respective input fields 1311 to 1314 by operating the input device of the manager-use terminal 404. Instead of inputting specific IP addresses, the server names may be inputted to the “from” input field 1311 and the “to” input field 1312. If server names are inputted, then the management computer 403 converts the inputted server names to IP addresses according to a conversion table (not shown) of the server names and corresponding IP addresses stored in the management computer 403.

The display region 1302 is a region where added setting content is displayed. The setting content addition button 1303 is a button for displaying a setting content addition screen 1330. The setting content addition screen 1330 has an operation selection field 1331, a target device input field 1332, a setting content type selection field 1333, and a parameter input field 1334. The operation selection field 1331 is a field where it is possible to select any of the operation types: “add”, “modify”, or “delete”. The target device input field 1332 is a field for inputting information identifying the target device.

The setting content type selection field 1333 is a field where it is possible to select the type of setting content item. The parameter input field 1334 is a field for inputting a parameter value according to the setting content selected in the setting content type selection field 1333. The parameter input field 1334 is updated to a parameter value according to the setting content selected in the setting content type selection field 1333. The setting content addition button 1335 is a button for adding information inputted to the setting content addition screen 1330 to the display region 1302.

The advance verification button 1304 is a button for sending a request to the management computer 403 to verify in advance information inputted to the input screen 1300. By pressing the advance verification button 1304, the information inputted to the input screen 1300 is sent from the manager-use terminal 404 to the management computer 403.

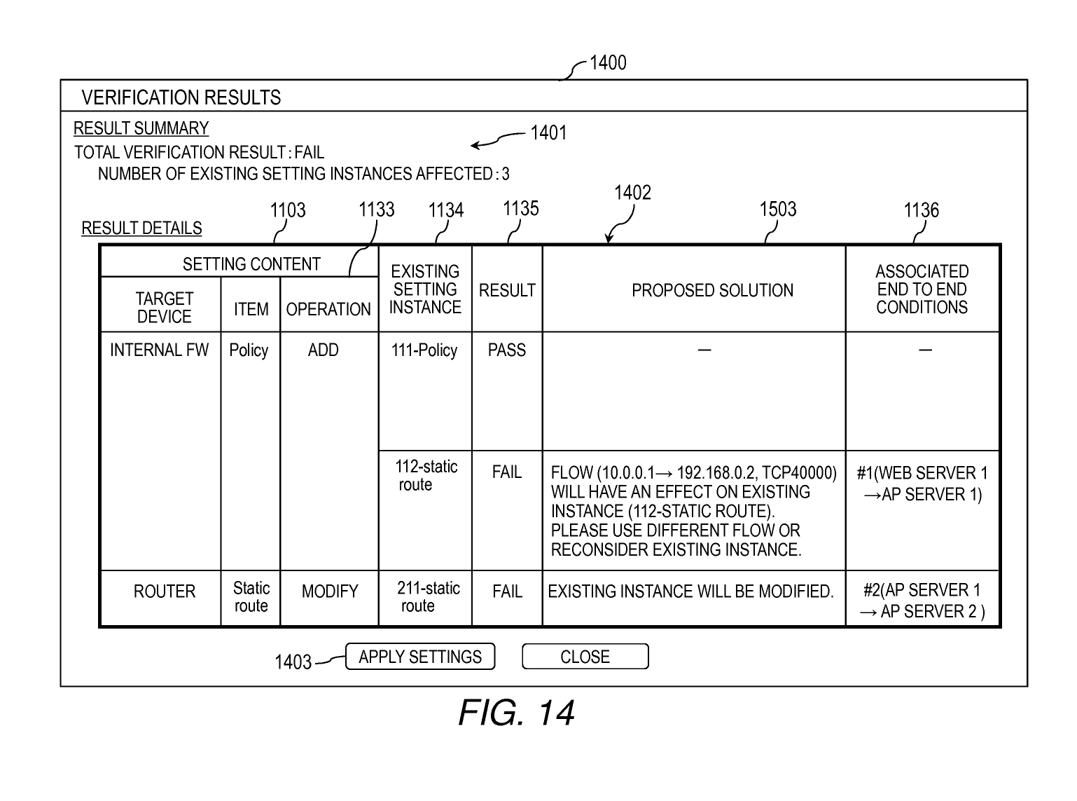

FIG. 13B is a descriptive drawing showing a selection example in the setting content addition screen 1330. If, in the setting content addition screen 1330, “delete” is selected in the operation selection field 1331, then the item to be deleted is displayed to be selectable. Specifically, the target device and the type of setting content are sent to the management computer 403, and the existing setting content (such as 111-Policy) of an existing setting instance corresponding to the target device and setting content type is sent from the management computer 403, and displayed so as to be selectable as shown in FIG. 14. If existing setting content (111-Policy, for example) is selected, other existing setting content that has not been selected (112-static route, 211-static route) is not deleted. If the user wishes to delete other existing setting content, then the user would select “ALL” after “111-Policy”.

FIG. 14 is a descriptive drawing showing an example of an output screen of an operating sequence of a management computer 403. The output screen 1400 is displayed in the display device of the manager-use terminal 404. The output screen 1400 is a screen that displays information sent from the management computer 403 as a result of the manager-use terminal 404 sending to the management computer 403 information inputted to the input screen 1300 shown in FIG. 13A.

The output screen 1400 displays a result summary 1401, result details 1402, and a setting execution button 1404. The result summary 1401 displays collective verification results and the number of existing setting instances affected. The collective verification result is “PASS” only when all confirmation results for individual setting content and existing setting instances return “PASS”. In the example of FIG. 14, the results for both “112-static route” and “211-static route” are “FAIL”, and thus, the collective verification result returns “FAIL”.

The result details 1402 are information in which a proposed solution field 1503 is added to the effect determination history information 526 (excluding the ID field 1101 and the confirmation completion time field 1102). If the result 1135 is “FAIL”, then the proposed solution field 1503 has stored therein a proposed solution based on the operation 1133. The proposed solution shows a flow having an overlap confirmed in the flow space.

The setting execution button 1403 is a button that, when pressed, issues a request to the management computer 403 to modify the settings.

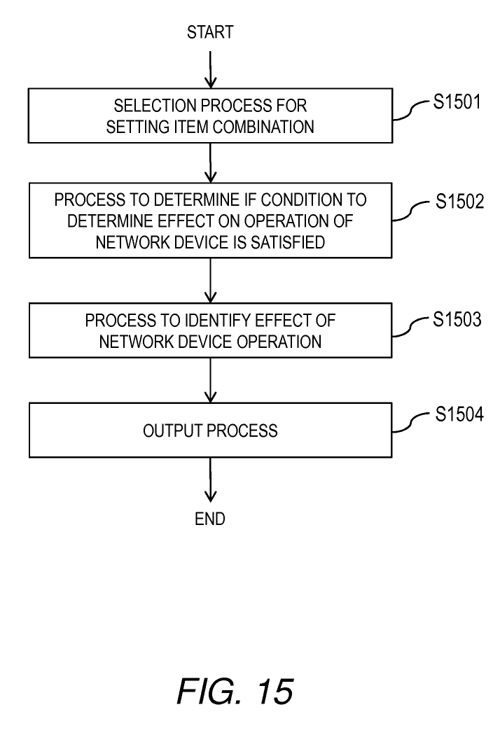

FIG. 15 is a flowchart showing an example of operation steps by the management computer 403. Steps S1501 to S1504 in FIG. 15 are processes executed by the effect confirmation program 511.

First, the management computer 403 executes a process to select a combination of setting items (step S1501). Specifically, the management computer 403 selects a specific combination from the effect determination information 525 that matches the combination of a first setting item for the network device 401 and a second setting item associated with the first setting item for the network device 401, for example. The first setting item is an item for an existing setting instance (existing setting policy 101, for example) and the second setting item is an added setting item (added policy 102, for example) inputted according to a request from the manager-use terminal 404, which is an external device, for example. If the combination of the first setting item and the second setting item exists in the effect determination information 525, then the combination of the setting content type 1002 and the associated setting instance type 1003 of the effect determination information 525 is selected as the specific combination.

Next, the management computer 403 executes a condition satisfaction determination process for conditions determining effects of the operation of the network device 401 (step S1502). Conditions determining effects of the operation of the network device 401 specifically refer to at least one condition among a flow usage 1032a of an associated setting instance type 1003 selected for the specific combination or a miscellaneous condition 1032b, for example.

Next, the management computer 403 executes a process to identify effects of the operation of the network device 401 (step S1503). Specifically, the management computer 403 executes the identification process (step S1503) on the basis of the determination results of the condition satisfaction determination process (step S1502), for example.

More specifically, if the conditions are satisfied according to the condition satisfaction determination step (step S1502), this means that the value of the parameter of the second setting item affects the first setting item, for example. Thus, in the identification process (step S1503), the management computer 403 associates the “FAIL” result indicating that the second setting item would be affected with the combination of the first setting item and the second setting item. On the other hand, if the management computer 403 finds that if the conditions are not satisfied according to the condition satisfaction determination step (step S1502), this means that the value of the parameter of the second setting item does not affect the first setting item. Thus, in the identification process (step S1503), the management computer 403 associates the “PASS” result indicating that the second setting item would not be affected with the combination of the first setting item and the second setting item.

Then, the management computer 403 executes an output process (step S1504) in which the identification results of the identification process (step S1503) are outputted, and the series of processes is ended. Specifically, the management computer 403 outputs as the identification results the combination of the first setting items and the second setting items to which effect confirmation information such as “PASS” and “FAIL” was associated, for example. The output destination may be the manager-use terminal 404, a display device (not shown) of the management computer 403, or the storage device 560.

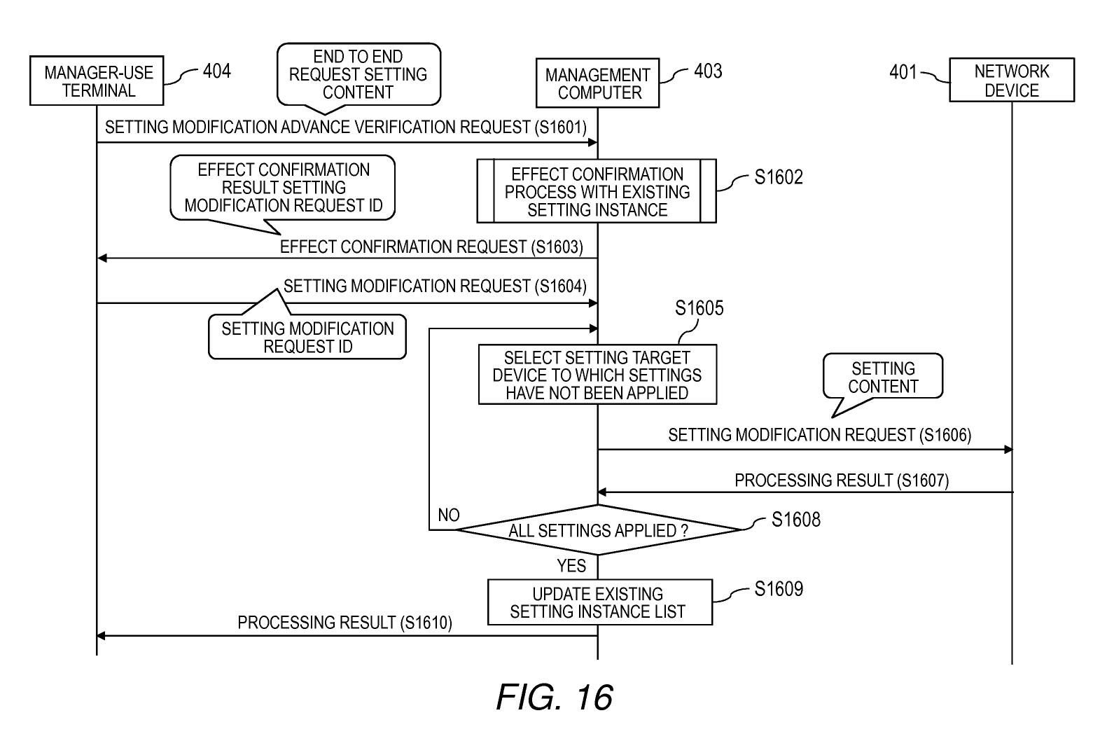

FIG. 16 is a sequence drawing showing one example of an operation sequence of the management computer 403. First, the manager-use terminal 404 sends a setting modification advance verification request to the management computer 403 (step S1601). The setting modification advance verification request is a request for verifying in advance setting modifications (add, modify, or delete) for setting content such as policies or end to end conditions for the network device 401. The setting modification advance verification request includes end to end conditions and setting content for which the setting modification advance verification request is to be made. Specifically, the information inputted into the input screen 1300 shown in FIG. 13 is included in the setting modification advance verification request. By pressing the advance verification button 1304 on the input screen 1300, the setting modification advance verification request is sent from the manager-use terminal 404 to the management computer 403.

When the management computer 403 receives the setting modification advance verification request, the management computer 403 stores the setting content and end to end conditions included in the setting modification advance verification request by the setting program 512 in the setting modification request information 521. Then, the management computer 403, using the effect confirmation program 511, executes an effect confirmation process for the existing setting instance (step S1602). The existing setting instance and the effect confirmation process (step S1602) are processes shown in FIGS. 1 to 3, and correspond to the selection process (step S1501), the condition satisfaction determination process (step S1502), and the identification process (step S1503). Details of the effect confirmation process (step S1602) are shown in FIG. 17.

If the management computer 403 executes the effect confirmation process (step S1602) for the existing setting instance, then the management computer 403 issues a setting modification request ID uniquely identifying the setting modification request information 521 that is based on the effect confirmation results attained by the effect confirmation process for the existing setting instance (step S1602), and send the effect confirmation results and setting modification request ID to the manager-use terminal 404 (step S1603). The method for determining the setting modification request ID is to start with 1 and add 1 to a previously used ID, for example. In this manner, the output screen 1400 shown in FIG. 15 is displayed in the display device of the manager-use terminal 404. This transmission corresponds to the output process (step S1504) of FIG. 15, for example.

Then, the manager-use terminal 404 sends the setting modification request to the management computer 403 (step S1604). Specifically, by pressing the setting execution button 1404 of the output screen 1400, for example, the setting modification request including the setting modification request ID is sent from the manager-use terminal 404 to the management computer 403.

When the management computer 403 receives the setting modification request, it identifies the setting modification request information 521 by using the setting program 512 to obtain the setting modification request ID from the setting modification request. The management computer 403 selects (step S1605) the network device 401 to which no settings have been made from the identified setting modification request information 521 using the existing setting collection program 513. The management computer 403 then sends the setting modification request including the setting content of the selected network device 401 (step S1606). In this case, the management computer 403 may send only the setting content for which “PASS” was returned as the effect confirmation result. Also, in step S1604, the setting execution button is pressed on the manager-use terminal 404, and thus, the manager is deemed to have given authorization. Thus, the management computer 403 may also send setting content for which “FAIL” was returned.

By receiving the setting modification request, the network device 401 updates the setting content according to the setting content included in the setting modification request using the existing setting collection program 513, and returns the setting results to the management computer 403 (step S1607).

The management computer 403 determines whether or not all settings have been made (step S1608). If there are settings that have not been made (step S1608:no), then the management computer 403 returns to step S1605. On the other hand, if all settings have been made (step 1608:yes), then the management computer 403 updates the existing setting instance list information 522 with the setting modification request information 521 using the existing setting collection program 513 (step S1609). Specifically, if the operation type of the setting modification request information 521 is “add”, for example, then the management computer 403 adds the setting content to be added to the existing setting instance list. If the operation type is “modify”, then the management computer 403 modifies the value of the parameters of the existing setting instance to be modified. If the operation type is “delete”, then the management computer 403 deletes the existing setting instance to be deleted.

Then, the management computer 403 sends the process results indicating that the existing setting instance list information 522 has been updated by the existing setting collection program 513 to the manager-use terminal 404 (step S1610). In this manner, the operating sequence of the management computer 403 ends.

FIG. 17 is a flow chart showing detailed process steps of the effect confirmation process (step S1602) for the existing setting instance shown in FIG. 16. First, the management computer 403 puts all setting instances and end to end conditions in correspondence with the flow space (step S1701). Specifically, the management computer 403 generates the intermediate tables 111 and 311 such as shown on the left side of (B) in FIGS. 1 to 3 using the first correspondence information 523 and the second correspondence information 524.

Next, the management computer 403 selects unprocessed setting content 604 from the setting modification request information 521 (step S1702). Specifically, the management computer 403 selects a setting target device 603 (internal FW, for example) that has not yet been selected, and then selects one setting content 604 (combination of item 641, operation 642, parameter 643, and value 644) that has not been selected in the selected setting target device 603.

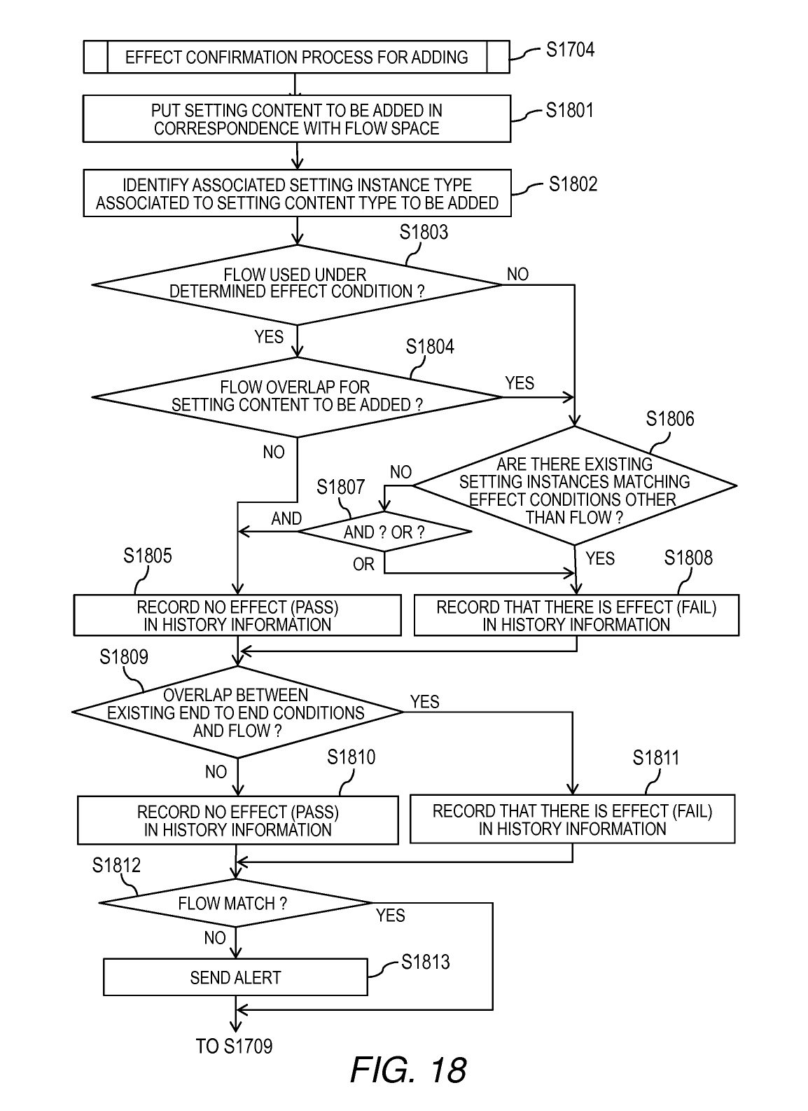

The management computer 403 determines whether the operation 642 among the selected setting content 604 is set to any one of add, modify or delete (step S1703). If the operation 642 is set to add (step S1703:add), the management computer 403 executes the effect confirmation step for adding (step S1704) and moves to the step S1709. Details of the effect confirmation process (step S1704) for adding are shown in FIG. 18.

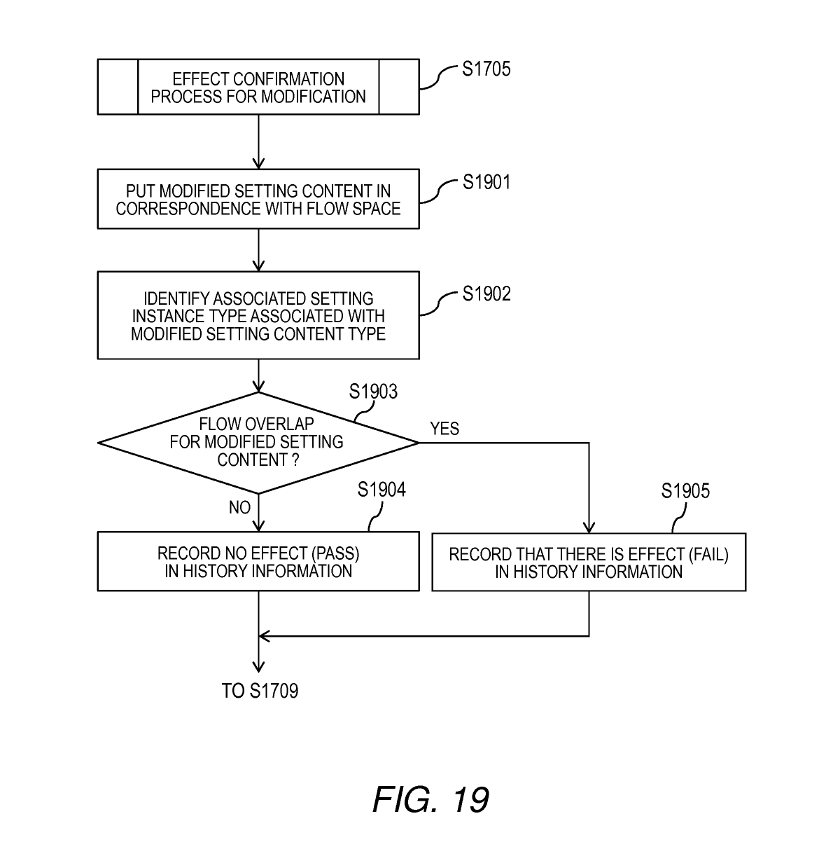

If the operation 642 among the setting content 604 is set to modify (step S1703:modify), the management computer 403 executes the effect confirmation step for modifying (step S1705) and moves to the step S1709. Details of the effect confirmation process (step S1705) for modification are shown in FIG. 19.

If the setting content 604 is set to delete (step S1703:delete), then the management computer 403 determines whether or not the setting instance to be deleted has been associated with the end to end conditions (step S1706). The setting instance to be deleted is setting content for an existing setting instance corresponding to the setting content 604 selected in the step S1702. If the setting content 604 selected from the setting modification request information 521 is setting content in which the policy (item 641) of the internal FW (setting target device 603) is to be deleted (operation 642), then the management computer 403 identifies as the setting instance to be deleted the setting instance including the policy (item 705) of the internal FW (device type 703) from the existing setting instance list information 522. The management computer 403 determines whether or not the identified setting instance to be deleted has been associated with the end to end conditions 702 of the existing setting instance list information 522.

If the setting instance to be deleted has not been associated with the end to end conditions 702 (step S1706:no), then the setting instance to be deleted cannot be placed in correspondence with the setting modification request information 521, and thus, the effect of the setting instance to be deleted does not need to be confirmed, and thus, the management computer 403 moves to step S1709.

On the other hand, if the setting instance to be deleted has been associated with the end to end conditions 702 (step S1706:yes), then the management computer 403 determines the setting instance to be deleted according to the setting content (step S1707). In such a case, as shown in FIG. 13B, for example, if only the setting instance (such as 111-Policy) is selected to be deleted, then only the setting instance selected to be deleted (such as 111-Policy) is set to be deleted. In such a case, the management computer 403 records “FAIL” in the result field 1135 of the effect determination history information 526 to indicate that there are other remaining setting instances (such as 112-static route and 121-static route) associated with the corresponding end to end conditions, or in other words, that there is an effect.

On the other hand, if “ALL” is selected in addition to the setting instance (such as 111-Policy) to be deleted, then in addition to the setting instance to be deleted (such as 111-Policy), the other setting instances associated with the corresponding end to end conditions (such as 112-static route and 121-static route) are also set to be deleted. In such a case, the management computer 403 records “PASS” in the result field 1135 of the effect determination history information 526 to indicate that there is no effect. Then the management computer 403 moves onto step S1709.

In step S1709, the management computer 403 determines whether or not there is setting content 604 in the setting modification request information 521 that has not been selected (step S1709). If there are settings that have not been selected (step S1709:yes), then the management computer 403 returns to step S1702. On the other hand, if there is no setting content that has not been selected (step S1709:no), then the effect confirmation process (step S1602) ends, and the management computer 403 moves onto step S1603.

FIG. 18 is a flow chart showing detailed process steps of the effect confirmation process (step S1704) during the adding of the setting content shown in FIG. 17. First, the management computer 403 puts the setting content 604 to be added in correspondence with the flow space (step S1801). Specifically, the management computer 403 generates the intermediate tables 112 and 211 such as shown on the right side of (B) in FIGS. 1 to 3 using the first correspondence information 523 and the second correspondence information 524.

Next, the management computer 403 identifies the associated setting instance type 1003 associated with the setting content type 1002 to be added with reference to the effect determination information 525 shown in FIG. 10 (step S1802). The step S1802 corresponds to the selection process shown in FIG. 15 (step S1501).

Next, the management computer 403 determines whether or not flow usage is applicable according to conditions affecting the instance of the associated setting instance type 1003 identified in the step S1802 (step S1803). If the flow usage 1032a is “applicable”, then the flow usage is applied (step S1803:yes) and the management computer 403 moves onto step S1804. If the flow usage 1032a is “-”, then the flow usage is not applied (step S1803:no) and the management computer 403 moves onto step S1805.

In step S1804, the management computer 403 determines flow overlap concerning the setting content 604 to be added, as shown (B) and (C) in FIGS. 1 to 3 (step S1804). If it is determined that there is no overlap (step S1804:no), then the management computer 403 moves onto step S1805.

On the other hand, if it is determined that there is an overlap (step S1805:yes), then the management computer 403 determines whether or not there are setting instances that match the conditions 1032 under which instances other than the flow usage 1032a of the associated setting instance type 1003 identified in step S1802 are affected (step S1806). If a miscellaneous condition 1032b, which is a condition 1032 affected by an instance other than the flow usage 1032a, is that “order is greater than setting content value”, then the management computer 403 determines whether or not an order value 707 of a parameter 706 of a setting instance is greater than a value 644 of “order” under the parameter 643 of the setting content 604 to be added. If it is greater (step S1806:yes), then the management computer 403 moves onto step S1808, and if it is not greater (step S1806:no), then the management computer 403 moves onto step S1807.

In step S1807, the management computer 403 determines whether the value of the AND/OR field 1032c of the associated setting instance type 1003 identified in step S1802 is “AND” or “OR” (step S1807). If the value is “AND” (step S1807:AND), then the management computer 403 moves onto step S1805. If the value is “OR” (step S1807:OR), then the management computer 403 moves onto step S1808. The steps S1803, S1804, S1806, and S1807 correspond to the condition satisfaction determination process (step S1502).

In step S1805, the management computer 403 records “PASS” in the result field 1135 of the effect determination history information 526 to indicate that there is no effect (step S1805), and moves onto step S1809.

In step S1808, the management computer 403 records “FAIL” in the result field 1135 of the effect determination history information 526 to indicate that there is an effect (step S1808), and moves onto step S1809. The steps S1805 and S1808 correspond to the identification process shown in FIG. 15 (step S1503).

In step S1809, the management computer 403 determines whether or not the setting content 604 to be added overlaps with the existing end to end conditions 702 in the flow space (step S1809). If there is no overlap (step S1810:no), the management computer 403 records “PASS” in the result field 1135 of the effect determination history information 526 to indicate that there is no effect (step S1810), and moves onto step S1812.

If there is an overlap (step S1809:yes), the management computer 403 records “FAIL” in the result field 1135 of the effect determination history information 526 to indicate that there is an effect (step S1811), and moves onto step S1812.

Then the management computer 403 determines whether or not the setting content 604 to be added (value 644 of parameter 643 of item 641:policy) matches the flow of the end to end conditions 602 to be added (step S1812). If there is no match (step S1812:no), then the management computer 403 puts up an alert (step S1813) and ends the effect confirmation process for adding (step S1804). If the flow matches (step S1812:yes), then the effect confirmation process during adding is ended (step S1804).

FIG. 19 is a flow chart showing detailed process steps of the effect confirmation process (step S1805) during the modification of the setting content shown in FIG. 17. First, the management computer 403 puts the setting content 604 to be added in correspondence with the flow space (step S1901). Specifically, the management computer 403 generates the intermediate tables 112 and 211 such as shown on the right side of (B) in FIGS. 1 to 3 using the first correspondence information 523 and the second correspondence information 524.

Next, the management computer 403 identifies the associated setting instance type 1003 associated with the setting content type 1002 that has been modified with reference to the effect determination information 525 shown in FIG. 11 (step S1902). The step S1902 corresponds to the selection process shown in FIG. 15 (step S1501).

Next, the management computer 403 determinates flow overlap for the modified setting content 604, as shown (B) and (C) in FIGS. 1 to 3 (step S1903). The step S1903 corresponds to the condition satisfaction determination process shown in FIG. 15 (step S1502). If there is no overlap (step S1903:no), the management computer 403 records “PASS” in the result field 1135 of the effect determination history information 526 to indicate that there is no effect (step S1904), and then ends the effect confirmation process during modification (step S1805). The steps S1904 and S1905 correspond to the identification process shown in FIG. 15 (step S1503).

If there is an overlap (step S1903:yes), the management computer 403 records “FAIL” in the result field 1135 of the effect determination history information 526 to indicate that there is an effect (step S1905), and then ends the effect confirmation process during modification (step S1805).

In this manner, according to Embodiment 1, the management computer 403 determines if there is overlap by mapping the value of the parameter of the setting item applied from an external source and the value of the setting item of an existing setting instance or a parameter of the end to end conditions, to a flow space. In other words, even if the setting items differ, if there are attributes mapped to the flow space in common, then overlap determination can be performed thereon. Thus, it is possible to expand the range of items that can be verified and to reduce verification omissions for a network configuration.

### Embodiment 2

Next, Embodiment 2 will be described. In Embodiment 1, an example was described in which, if there was a setting modification advance modification request from the manager-use terminal 404 including setting content 604 and end to end conditions 602, the management computer 403 performs effect confirmation using the setting content 604 and the existing setting instances (type 703 to value 707 in FIG. 7) and end to end conditions 702. By contrast, in Embodiment 2 is an example in which, even if there is no setting modification advance modification request from a manager-use terminal 404 including setting content 604, a management computer 403 performs effect confirmation using the existing setting instances (type 703 to value 707 in FIG. 7) and end to end conditions 702.

The effect confirmation of Embodiment 2 may be executed when an effect confirmation request for an existing setting instance is issued from the manager-use terminal 404. Also, the effect confirmation of Embodiment 2 may be performed repeatedly: periodically, for example. In Embodiment 2, only aspects differing from Embodiment 1 will be described.

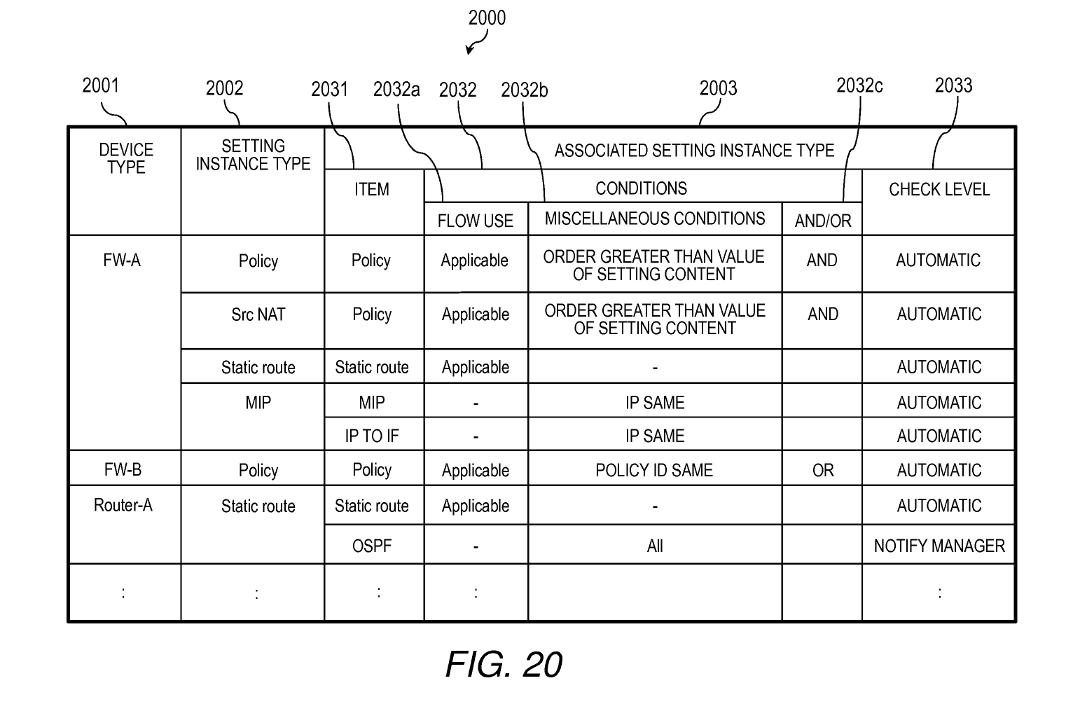

FIG. 20 is a descriptive drawing showing one example of the effect determination information of Embodiment 2. The effect determination information 2000 is information for determining the effect between an existing setting instance and an associated setting instance. The difference from the effect determination information 525 shown in FIG. 10 (hereinafter, the “first effect determination information 525”) is that, whereas the first effect determination information 525 had a setting content type 1002, the effect determination information 2000 of Embodiment 2 (hereinafter, the “second effect determination information 2000”) has a setting instance type 2002 instead of the setting content type 1002. Aside from this, the second effect determination information 2000 is the same as the first effect determination information 525.

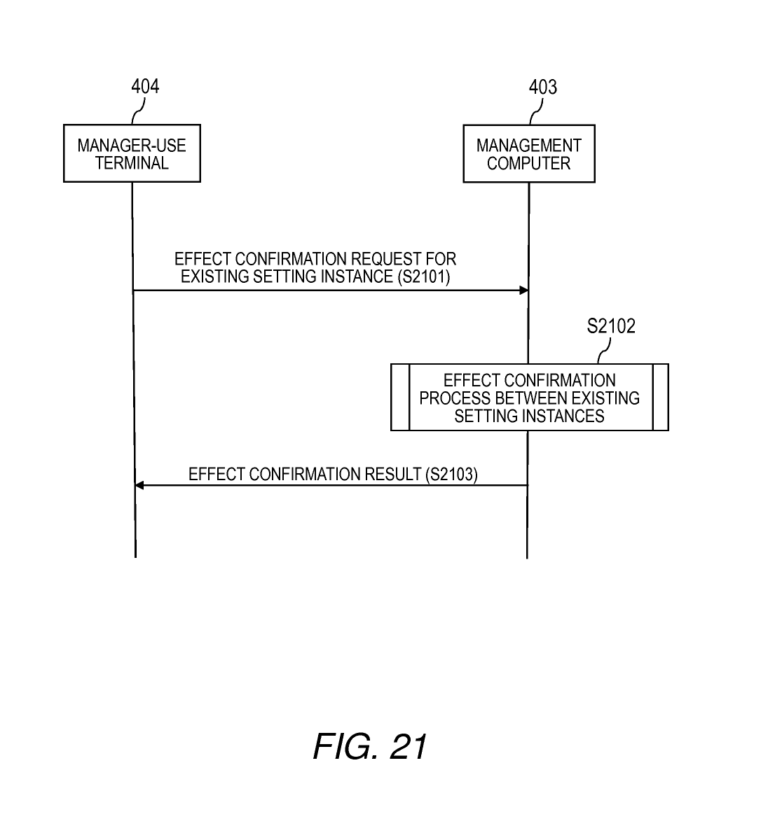

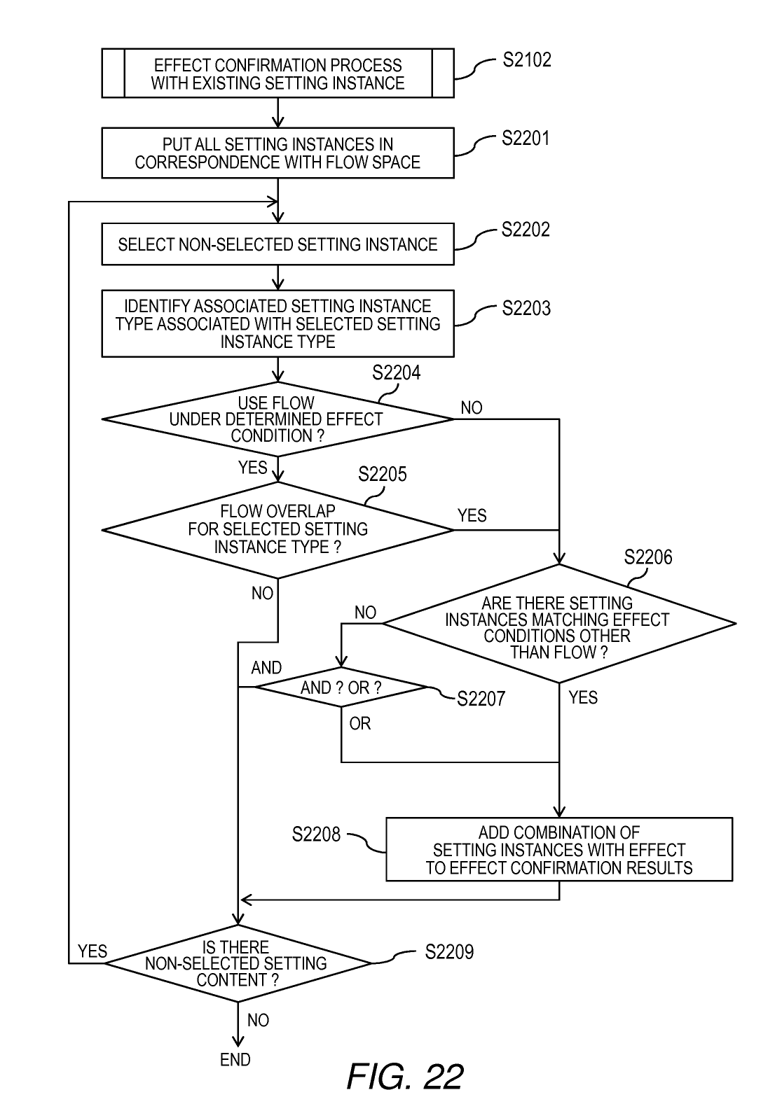

FIG. 21 is a sequence drawing showing one example of an operation sequence of the management computer 403 of Embodiment 2. The manager-use terminal 404 sends an existing setting instance effect confirmation request to the management computer 403 at an arbitrary timing. When the management computer 403 receives the existing setting instance effect confirmation request, the management computer 403 executes an effect confirmation process between existing setting instances (step S2102). Details of the effect confirmation process (step S2102) between existing setting instances is described in FIG. 22.

Then, the management computer 403 sends to the manager-use terminal 404 effect confirmation results from the effect confirmation process (step S2102) between existing setting instances (step S2103). In this manner, the operating sequence of the management computer 403 of Embodiment 2 ends.

### Effect Confirmation Process Between Existing Setting Instances

FIG. 22 is a flow chart showing detailed process steps of the effect confirmation process (step S2102) between existing setting instances shown in FIG. 21. First, the management computer 403 puts all setting instances in the existing setting instance list information 522 (entries identified in the setting target device 603 and item 641) in correspondence with the flow space using the first correspondence information 523 shown in FIG. 8 (step S2201).

Next, the management computer 403 selects non-selected instances (entries identified in the setting target device 603 and the item 641) from the existing setting instance list information 522 (step S2202). Then, the management computer 403 identifies the setting instance type 2002 corresponding to the selected setting instance from the second effect determination information 2000, and identifies an associated setting instance type 2003 corresponding to the identified setting instance type 2002 from the second effect determination information 2000 (step S2203).

Then, the management computer 403 determines whether or not flow usage 2032a is applicable according to conditions 2032 affecting the instance of the associated setting instance type 2003 identified in the step S1802 (step S2204). If the flow usage 2032a is “applicable”, then the flow usage is applied (step S2204:yes) and the management computer 403 moves onto step S2205. If the flow usage 2032a is “-”, then the flow usage is not applied (step S2204:no) and the management computer 403 moves onto step S2206.

In step S2205, as shown (B) and (C) in FIGS. 1 to 3, the management computer 403 determines flow overlap between the setting instance type 2002 of the selected setting instance and the associated setting instance 2003 (step S2205). Specifically, the flow overlap determination is executed between the selected setting instance and the associated setting instance identified by the associated setting instance type 2003 (existing setting instance of the same type as the selected setting instance), for example. If it is determined that there is no overlap (step S2205:no), then the management computer 403 moves onto step S2209.

On the other hand, if it is determined that there is an overlap (step S2205:yes), then the management computer 403 determines whether or not there are setting instances that match a miscellaneous condition 2032b, which is a condition 2032 under which instances other than the flow usage of the associated setting instance type 2003 identified in step S2203 are affected (step S2206). If the miscellaneous condition 2032b, which is a condition 2032 other than the flow usage 2032a, is that “order is greater than setting content value”, then the management computer 403 determines whether or not an order value 707 of a parameter 706 of a selected setting instance is greater than a value 707 of “order” under the parameter 706 of the setting instance being compared. If it is greater (step S2206:yes), then the management computer 403 moves onto step S2208, and if it is not greater (step S2206:no), then the management computer 403 moves onto step S2207.

In step S2207, the management computer 403 determines whether the value of the AND/OR field 2032c of the associated setting instance type 2003 identified in step S2203 is “AND” or “OR” (step S2207). If the value is “AND” (step S2207:AND), then the management computer 403 moves onto step S2209. If the value is “OR” (step S2207:OR), then the management computer 403 moves onto step S2208.

In step S2208, the management computer 403 adds to the effect confirmation results a group of setting instances that are affected, or in other words, a group of selected setting instances and associated setting instances identified by the associated setting instance type 2003 (step S2208), and moves onto step S2209.

The management computer 403 determines whether or there is non-selected setting content (step S2209). If there are settings that have not been selected (step S2209:yes), then the management computer 403 returns to step S2202. On the other hand, if there are no settings that have not been selected (step S2209:no), then the management computer 403 ends the effect confirmation process (step S2202) between existing setting instances. Then, the effect confirmation results stored in step S2209 are sent to the manager-use terminal 404 (step S2203).

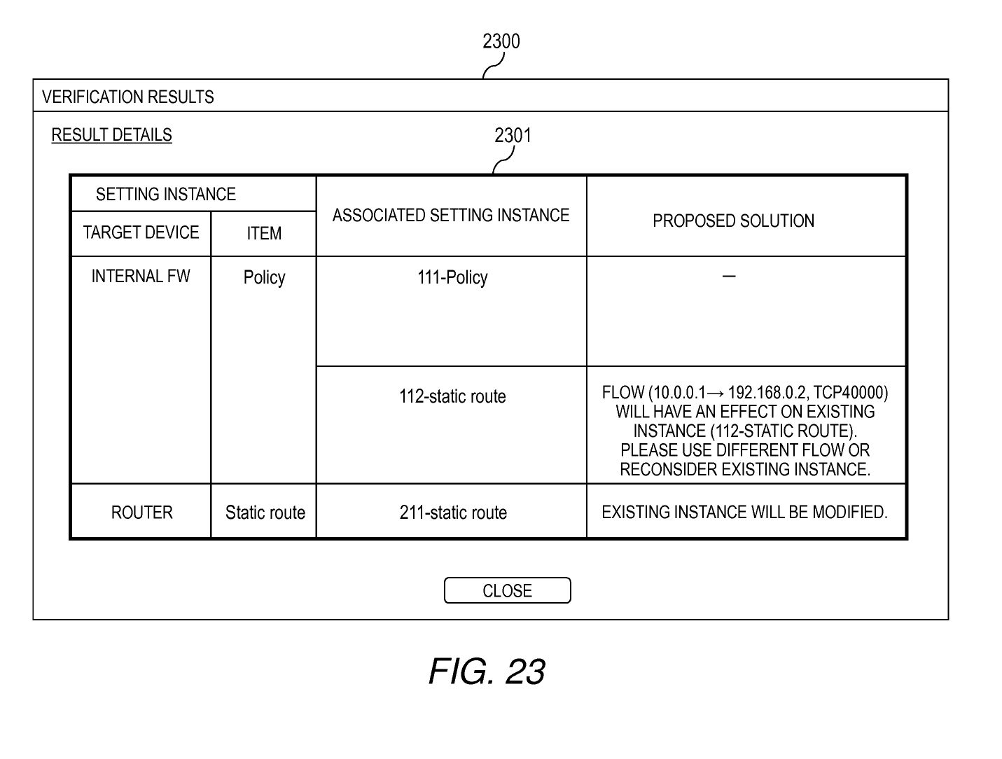

FIG. 23 is a descriptive drawing showing one example of an output screen of Embodiment 2. The output screen 2300 is displayed in the display device of the manager-use terminal 404. The output screen 2300 displays effect confirmation results sent from the management computer 403 in step S2203 as result details 2301. The difference between the output screen 2300 and the output screen 1400 of FIG. 15 (hereinafter, the “first output screen 1400”) is that a result summary 1401 is displayed in the first output screen 1400, whereas no result summary is displayed in the output screen 2300 of Embodiment 2 (hereinafter, the “second output screen 2300”). In the second output screen 2300, all existing setting instances displayed in the result details 2301 are tagged “FAIL” in the result field 1135 of the effect determination history information 526, indicated that there is an effect, and thus, the result summary is not displayed.

Also, whereas the setting content is displayed in the result details 1402 of the first output screen 1400, setting instances are displayed in the result details 2301 of the second output screen 2300. Whereas the results and associated end to end conditions are displayed in the result details 1402 of the first output screen 1400, the results and associated end to end conditions are not displayed in the result details 2301 of the second output screen 2300.

Thus, even if there are no setting modification requests, the management computer 403 can confirm whether or not the existing settings are applied correctly.

In this manner, according to Embodiment 2, the management computer 403 determines if there is overlap without an external request by mapping the value of the parameter of the setting item of an existing setting instance and the value of a parameter of a setting item of the existing setting instance or the end to end conditions, to a flow space. In other words, it is possible to verify after the fact whether or not existing settings were correctly applied. For example, in Embodiment 1, adding, modifying, or deletion of setting items is ultimately performed by a manager, and thus, the management computer 403 of Embodiment 2 can perform autonomous verification that settings from such an operation were applied correctly after settings were made.

As described above, according to the present embodiment, the management computer 403 maps values of parameters of setting items or values of parameters of end to end conditions to flow information attributes using the first correspondence information and the second correspondence information, and executes overlap confirmation between parameters of the same attribute. In other words, the overlap determination is executed for parameter values not only among the same items but among differing items. Thus, it is possible to confirm before and after when settings are to be modified which items will be affected by performing operations on certain items. Thus, it is possible to reduce omissions of verification in a network configuration.

It should be noted that this invention is not limited to the above-mentioned embodiments, and encompasses various modification examples and the equivalent configurations within the scope of the appended claims without departing from the gist of this invention. For example, the above-mentioned embodiments are described in detail for a better understanding of this invention, and this invention is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

Although the present disclosure has been described with reference to exemplary embodiments, those skilled in the art will recognize that various changes and modifications may be made in form and detail without departing from the spirit and scope of the claimed subject matter.

1. A management computer coupled to a network device, comprising: a processor that executes a program;
a storage unit that stores the program to be executed by the processor; and
an interface that controls communication with the network device,
wherein the storage unit stores effect determination information that defines conditions for determining an effect of an operation to the network device, the conditions being applied to a combination of setting items for the network device, and
wherein the processor executes:
a selection process of selecting, from among the combination of setting items for the network device in the effect determination information, a specific combination matching a combination of a first setting item for the network device and a second setting item associated with the first setting item for the network device;
a determination process of determining whether or not the combination of the first setting item and the second setting item satisfies the conditions applied to the specific combination if the specific combination is selected in the selection process;
an identification process of identifying the presence or absence of an effect resulting from an operation to the network device on the basis of determination results obtained by the determination process; and
an output process of outputting identification results obtained by the identification process.

2. The management computer according to claim 1,
wherein the storage unit stores first correspondence information in which parameters associated with the setting items of the network device are put in correspondence with attribute information defining the type of the parameters,
wherein the effect determination information stores information determining whether or not the first correspondence information is used as the conditions,
wherein, in the determination process, the processor is made to use the first correspondence information as the conditions applied to the specific combination, and if first attribute information corresponding to a first parameter associated with the first setting item in the first correspondence information is the same as second attribute information corresponding to a second parameter associated with the second setting item in the first correspondence information, the processor determines whether or not there is an overlap between a value of the first parameter and a value of the second parameter, and
wherein, in the output process, the processor outputs determination results of whether or not there is an overlap between the value of the first parameter and the value of the second parameter.

3. The management computer according to claim 2, wherein the value of the first parameter is a value already set in the network device, and the value of the second parameter is added to the network device or modified therein according to an external request.

4. The management computer of claim 2, wherein the value of the first parameter and the value of the second parameter are values already set in the network device.

5. The management computer according to claim 2,
wherein, in the identification process, if it is determined by the determination process that there is an overlap, the processor puts effect confirmation information indicating that the value of the second parameter would affect an operation of the network device according to the first parameter in association with the combination of the first setting item and the second setting item, and if it is determined by the determination process that there is no overlap, the processor puts effect confirmation information indicating that the value of the second parameter would not affect an operation of the network device according to the first parameter in association with the combination of the first setting item and the second setting item, and
wherein, in the output process, the processor outputs as the identification results the combination of the first setting item and the second setting item to which effect confirmation information was associated.

6. The management computer according to claim 1,
wherein the storage unit stores first correspondence information in which a parameter associated with a setting item for the network device is put in correspondence with attribute information defining a type of the parameter, and second correspondence information in which a parameter associated with end to end conditions indicating whether or not communication is possible from a source to a destination through the network device is put in correspondence with attribute information defining a type of the parameter,
wherein, in the determination process, if third attribute information corresponding to a third parameter associated with the end to end conditions in the second correspondence information is the same as second attribute information corresponding to a second parameter associated with the second setting item in the first correspondence information, the processor determines whether or not there is an overlap between a value of the third parameter and a value of the second parameter, and
wherein, in the output process, the processor outputs determination results of whether or not there is an overlap between the value of the third parameter and the value of the second parameter.

7. The management computer according to claim 6, wherein the value of the third parameter is a value already set in the network device, and the value of the second parameter is added to the network device or modified therein according to an external request.

8. The management computer of claim 6, wherein the value of the second parameter and the value of the third parameter are values already set in the network device.

9. The management computer according to claim 6,
wherein, in the identification process, if it is determined by the determination process that there is an overlap between the value of the third parameter and the value of the second parameter, the processor puts effect confirmation information indicating that the value of the second parameter would affect an operation of the network device according to the third parameter in association with a combination of the end to end conditions and the second setting item, and if it is determined by the determination process that there is no overlap, the processor puts effect confirmation information indicating that the value of the second parameter would not affect an operation of the network device according to the third parameter in association with the combination of the end to end conditions and the second setting item, and
wherein the output process outputs as the identification results the combination of the end to end conditions and the second setting item to which effect confirmation information is associated.

10. The management computer according to claim 3, wherein the processor updates values already set in the network device on the basis of the identification results.

11. A management method by a management computer coupled to a network device,
wherein the management computer includes: a processor that executes a program; a storage unit that stores the program to be executed by the processor; and an interface that controls communication with the network device,
wherein the storage unit stores effect determination information that defines conditions for determining an effect of an operation to the network device, the conditions being applied to a combination of setting items for the network device, and
wherein the processor executes:
a selection process of selecting, from among the combination of setting items for the network device in the effect determination information, a specific combination matching a combination of a first setting item for the network device and a second setting item associated with the first setting item for the network device;
a determination process of determining whether or not the combination of the first setting item and the second setting item satisfies the conditions applied to the specific combination if the specific combination is selected in the selection process;
an identification process of identifying the presence or absence of an effect resulting from an operation to the network device on the basis of determination results obtained by the determination process; and
an output process of outputting identification results obtained by the identification process.

12. The management method according to claim 11,
wherein the storage unit stores first correspondence information in which parameters associated with the setting items of the network device are put in correspondence with attribute information defining the type of the parameters,
wherein the effect determination information stores information determining whether or not the first correspondence information is used as the conditions,
wherein, in the determination process, the processor is made to use the first correspondence information as the conditions applied to the specific combination, and if first attribute information corresponding to a first parameter associated with the first setting item in the first correspondence information is the same as second attribute information corresponding to a second parameter associated with the second setting item in the first correspondence information, the processor determines whether or not there is an overlap between a value of the first parameter and a value of the second parameter, and
wherein, in the output process, the processor outputs determination results of whether or not there is an overlap between the value of the first parameter and the value of the second parameter.

13. The management method according to claim 12, wherein the value of the first parameter is a value already set in the network device, and the value of the second parameter is added to the network device or modified therein according to an external request.

14. The management method according to claim 12, wherein the value of the first parameter and the value of the second parameter are values already set in the network device.

15. The management method according to claim 11,
wherein the storage unit stores first correspondence information in which a parameter associated with a setting item for the network device is put in correspondence with attribute information defining a type of the parameter, and second correspondence information in which a parameter associated with end to end conditions indicating whether or not communication is possible from a source to a destination through the network device is put in correspondence with attribute information defining a type of the parameter,
wherein, in the determination process, if third attribute information corresponding to a third parameter associated with the end to end conditions in the second correspondence information is the same as second attribute information corresponding to a second parameter associated with the second setting item in the first correspondence information, the processor determines whether or not there is an overlap between a value of the third parameter and a value of the second parameter, and
wherein, in the output process, the processor outputs determination results of whether or not there is an overlap between the value of the third parameter and the value of the second parameter.

16. A non-transitory recording medium having stored thereon a program executed by a processor of a management computer coupled to a network device, the non-transitory recording medium being readable by the processor,
wherein a storage unit of the management computer stores effect determination information that defines conditions for determining an effect of an operation to the network device, the conditions being applied to a combination of setting items for the network device, and
wherein the program causes the processor to execute:
a selection process of selecting, from among the combination of setting items for the network device in the effect determination information, a specific combination matching a combination of a first setting item for the network device and a second setting item associated with the first setting item for the network device;
a determination process of determining whether or not the combination of the first setting item and the second setting item satisfies the conditions applied to the specific combination if the specific combination is selected in the selection process;
an identification process of identifying the presence or absence of an effect resulting from an operation to the network device on the basis of determination results obtained by the determination process; and
an output process of outputting identification results obtained by the identification process.

17. The non-transitory recording medium according to claim 16,
wherein the storage unit stores first correspondence information in which parameters associated with the setting items of the network device are put in correspondence with attribute information defining the type of the parameters,
wherein the effect determination information stores information determining whether or not the first correspondence information is used as the conditions,
wherein, in the determination process, the processor is made to use the first correspondence information as the conditions applied to the specific combination, and if first attribute information corresponding to a first parameter associated with the first setting item in the first correspondence information is the same attribute information as second attribute information corresponding to a second parameter associated with the second setting item in the first correspondence information, the processor is made to execute a process of determining whether or not there is an overlap between a value of the first parameter and a value of the second parameter, and
wherein, in the output process, the processor is made to execute a process of outputting determination results of whether or not there is an overlap between the value of the first parameter and the value of the second parameter.

18. The non-transitory recording medium according to claim 17, wherein the value of the first parameter is a value already set in the network device, and the value of the second parameter is added to the network device or modified therein according to an external request.

19. The non-transitory recording medium according to claim 17, wherein the value of the first parameter and the value of the second parameter are values already set in the network device.

20. The non-transitory recording medium according to claim 16,
wherein the storage unit stores first correspondence information in which a parameter associated with a setting item for the network device is put in correspondence with attribute information defining a type of the parameter, and second correspondence information in which a parameter associated with end to end conditions indicating whether or not communication is possible from a source to a destination through the network device is put in correspondence with attribute information defining a type of the parameter,
wherein, in the determination process, if third attribute information corresponding to a third parameter associated with the end to end conditions in the second correspondence information is the same as second attribute information corresponding to a second parameter associated with the second setting item in the first correspondence information, the processor is made to execute a process of determining whether or not there is an overlap between a value of the third parameter and a value of the second parameter, and
wherein, in the output process, the processor is made to execute a process of outputting determination results of whether or not there is an overlap between the value of the third parameter and the value of the second parameter.
